(19) United States
(12) Patent Application Publication
(10) Pub. No.: US 2003/0101003 A1
(43) Pub. Date: May 29, 2003

(54) Methods for representing sequence-dependent contextual information present in polymer sequences and uses thereof

(76) Inventors: Albert S. Benight, Schaumburg, IL (US); Petr Pancoska, Evanston, IL (US); Anton J. Hopfinger, Lake Forest, IL (US); Peter V. Riccelli, Tinley Park, IL (US)

Correspondence Address: FISH & RICHARDSON PC, 225 FRANKLIN ST, BOSTON, MA, 02110, US

(21) Appl. No.: 10/178,070

(22) Filed: Jun. 21, 2002

Related U.S. Application Data
(60) Provisional application No. 60/299,911, filed on Jun. 21, 2001.

(51) Int. Cl. G01N 31/00

(52) U.S. Cl. 702/22

(57) ABSTRACT

The invention includes methods of representing polymer sequences in a way that reveals important position-specific contextual information. The representations can be used to determine a number of properties of polymers, such as protein and nucleic acid sequences, including the identification of secondary domain structures, folding rate constants, and the effects of altering (e.g., mutating) monomers. In addition, the representations can be used to compare polymers and thereby identify important structural and functional characteristics of polymers.

### RELATED APPLICATIONS

This application claims priority to U.S. S No. 60/299,911, filed on Jun. 21, 2001, the content of which are incorporated herein in their entirety by reference.

### FIELD OF THE INVENTION

The present invention relates to new methods of representing polymer sequences and the use of such representations to predict properties of the polymer sequences and fragments thereof.

### BACKGROUND OF THE INVENTION

Consider a sequence of chemical monomers linked to one another so as to form a linear array, such as a polymer. Most, if not all, of the information coding for the molecular behavior of the polymer chain are contained in the sequence of monomers, and executed by the entire repertoire of physical and chemical interactions of the monomers with solvent molecules and/or interactions with other monomers comprising the polymer chain. As a result, all the molecular (chemical, physical, biological, functional) behaviors and properties of monomer units in a linear chain of monomers are modulated or intrinsically dependent to some extent on the other monomers in the polymer chain. Thus, a monomer embedded in a linear polymer sequence may have very different properties and behavior in the global context compared to its behavior as an individual isolated monomer.

An important problem that remains unsolved in the biological sciences is how to predict the structure, function, and related physical properties of a sequence based on the linear order of the monomers that constitute the sequence. To date, the best results, in terms of inferring information about the structure and/or function of a sequence of interest, have been obtained when the sequence of interest shared either sequence or structural homology with another sequence for which structural and/or functional information was available.

Typically, when linear sequences of different polymers are compared, the order of monomeric units that give rise to common recognizable features are classified as “similar”, “conserved” or “homologous” if there is substantial equivalence of monomer chemical identities at aligned positions. Such classifications form the basis of the majority of proteomics and genomics methods currently used to search for correlations between the structure and function of biopolymers. In these methods, the order of monomers in a sequence of interest is compared to a database of biopolymers comprised of the same type of monomer units, whose linear sequences and secondary and tertiary structures and/or functions are known. Based on the results of the comparisons, molecular properties of the sequence of interest are inferred to be similar to the molecular properties of homologous biopolyers.

In the case of structural alignment, two polymers with known secondary and three-dimensional tertiary structures that do not have significant sequence homology can be compared. The common secondary structural motifs (secondary structure segments, loop hinges, etc.) of the three dimensional structures of the two polymers are aligned, and then the sequences of the aligned regions from the polymers are analyzed for recognizable patterns, order or other important similar features.

Current methods are limited by the fact that they require the sequence of interest to have a certain minimal amount of homology with another sequence (e.g., at least 20% identity in the case of proteins) or a known structure, and that something must be known about the structure or function of the known sequence or structure, in order to learn anything about the sequence of interest. Thus, when a sequence of interest is found to be homologous to a sequence for which no structural or functional information is available, then nothing can be said about the structure or function of the sequence of interest. Furthermore, simply knowing that one sequence can be aligned with another does not provide an indication as to the relative importance of the residues in each sequence with respect to their structure and function.

Another shortcoming of conventional alignment approaches lies in their inability to effectively treat hetero-molecular interactions, defined as those interactions that occur between two or more molecules comprised of the same type of monomers, as is the case for protein/protein or DNA/DNA interactions, for example. Hetero-molecular interactions can also be those that occur between molecules comprised of different types of monomer units. For example, nucleic acid/protein interactions. Using conventional FASTA methods it is not possible to align and compare protein sequences (comprised of 20 different types of monomer units) with DNA sequences (comprised of four nucleic acid bases).

### SUMMARY OF THE INVENTION

The present invention provides novel methods of representing and analyzing polymer sequences so as to elucidate important structural and functional properties of the sequences, including the prediction of secondary structure, structural homology, active site residues, and the effects of mutations, as well as predictions of regions of interaction between two polymers. The invention is based on a consideration of monomer context as the essential medium of the encoded information, thereby removing the need for comparisons with external reference sequences. Thus, the present invention can be used to analyze the sequence context of biopolymers that lack obvious sequence homology with known proteins and have unknown structures. Comparisons to reference molecules in an external database are not required although they might be used in particular applications if necessary.

Accordingly, in one aspect, the invention features a method of representing contextual information present at a specific position in a polymer, e.g., a protein sequence (e.g., a naturally occuring protein, an altered protein, a protein containing non-natural amino acids, or fragments thereof) or nucleic acid sequence (e.g., DNA, RNA, or fragments thereof)) the method comprising constructing a Position Vector Descriptor (PVD) for the position. PVDs can be constructed as described herein. For example, constructing a PVD can comprise: calculating functional descriptors (FD_{P}s) for each position in the polymer, wherein the FD_{P}s are calculated with respect to a specific pre-selected monomer, P; and combinding the calculated FD_{P}s into a single vector having m elements, where m is equal to the number of different types of monomers in the polymer and each element represent a specific monomer. In some embodiments, the PVD is normalized, e.g., by subtracting the mean of the element values from each of the elements, and rescaled, e.g., from −1 to +1. In some embodiments, the PVD is simplified to consist, e.g., of a smaller number of elements. In preferred embodiments, a simplified PVD contains a subset of elements, e.g., one, two, three, four, or more context leading monomers.

In another aspect, the invention features a methods of representing a polymer sequence (e.g., a protein sequence or nucleic acid sequence), the method comprising: obtaining a position vector descriptor (PVD) for one or more positions in the polymer; and replacing the monomer(s) with the corresponding PVD(s) in the representation of the polymer. In some embodiments, a PVD is obtained for all of the positions in the polymer. In some embodiments, the PVD is simplified, e.g., to include one or just a few element, e.g., one, two, three, four, or more, context leading monomers. In some embodiments, the PVD(s) is/are simplified to include only a single element, the context leading monomer (CLM).

In another aspect, the methods of the invention include predicting the effects of a change in sequence on a protein, the method comprising: obtaining a mathematical relationship that predicts, e.g., the effects of a change in sequence on a protein, wherein the input variable for the mathematical relationship is the difference between the value of a PVD element corresponding to the changed monomer and the value of a PVD element corresponding to the original monomer, and wherein the two PVD elements are from the same PVD and the PVD represents the position at which the change is located in the protein; obtaining a PVD representing a position of interest in the protein; and using (i) the difference between elements of the PVD representing the position of interest in the protein and (ii) the mathematical relationship to calculate the predicted effects of a change in sequence on, e.g., at least one physical property of the protein.

In some embodiments, the methods includes obtaining the mathematical relationship comprises: obtaining a set of data describing the effects of one or more specific changes on, e.g., at least one physical property of the protein; obtaining a PVD for each position in the protein corresponding to a position having such a change; for each change for which data is available, calculating the difference between an element of the PVD corresponding to the mutant monomer and an element of the PVD corresponding to the wild-type monomer, wherein the PVD represents the position of the mutation; and performing, e.g., regression analysis to identify a mathematical relationship between the differences in the PVD elements and the effects of the mutations. In some embodiments, the physical property being predicted is protein stability. In some embodiments, the obtained PVDs were generated from calculated FDs, wherein a triangular impulse function was used to calculate the FDs, e.g., a triangular impulse function having a width, W, that was optimized.

In another aspect, the methods of the invention include predicting secondary structure boundaries in a protein, the method comprising: obtaining PVDs for each amino acid position in the protein sequence; constructing a leading monomer distribution map (LMDM) for the protein; and dividing the LMDM into segments representing predicted units of secondary structure, wherein each segment contains, e.g., an integer number of context centers. In some embodiments, a fixed number of context centers, e.g., 3, 5, preferably 4, on the LMDM define each segment of secondary structure. In some embodiments, the obtained PVDs were generated from calculated FDs, wherein, e.g., a triangular impulse function was used to calculate the FDs. In some embodiments, the triangular impulse function had a width, W, that was optimized.

In another embodiments, the methods of the invention include identifying structural similarities, e.g., secondary, tertiary, or quaternary structure similarities, of a protein, the method comprising: obtaining PVDs for some or all amino acid position in the protein sequence; determining the effective primary sequence of the protein; and searching a protein database for similar sequences, e.g., structurally homologous sequences, to the effective primary sequence of the protein. In some embodiments, the sequences present in the protein database are effective primary sequences. In some embodiments, the obtained PVDs were generated from calculated FDs, wherein, e.g., a triangular impulse function was used to calculate the FDs. In some embodiments, the triangular impulse function has a width, W, that was optimized.

In another aspect, the methods of the invention include identifying positions of contextual similarity in a pair of polymers, the method comprising: obtaining a first set of PVDs describing one or more positions in the first polymer and a second set of PVDs describing one or more positions in the second polymer; calculating a difference matrix for the first set of PVDs with respect to the second set of PVDs; identifying the elements in the resulting difference matrix that are in a predetermined range, e.g., small in magnitude; and optionally, displaying graphing the elements of the difference matrix that are small in magnitude, e.g., less than 5% of the value of the maximal difference in the matrix. In some embodiments, the PVDs of the first and second sets have been normalized and rescaled. In some embodiments, the polymers are proteins. In some embodiments, the pair of polymers have different sequences. In some embodiments, the PVDs have been generated from calculated FDs, wherein, e.g., the function F used to calculate the FDs represents the tendency of an amino acid residue to stabilize the interaction between two protein surfaces.

In another aspect, the methods of the invention include identifying positions of contextual similarity in a polymer, the method comprising:

a) obtaining a set of PVDs describing one or more positions in the polymer, wherein the set of PVDs has been simplified to include a subset of elements, e.g., one, two, three, four, or more, context leading monomers;

b) performing pairwise comparrisons of each PVD (CLXPVD) from the set of PVDs, wherein two PVDs that have a threshold number, t, of CLMs in common are identified as representing monomer positions that are contextually similar;

c) optionally, generating a matrix (E-MAAPTM) representing the results of step (b).

In some embodiments, X has a value equal to less than half the number of elements in a PVD and t is less than X. In some embodiments, that has not been simplifiedIn some embodiments, each position in the matrix corresponds to the results of a single pair-wise comparison of PVDs, and wherein a value of “1” is assigned to positions in which the two PVDs are found to be contextually similar and a value of “0” is assigned to positions in which the two PVDs are not found to be contextually similar. In some embodiments, the first and second sets of PVDs contain PVDs describing all positions in the polymer. In some embodiments, the PVDs have been generated by a method comprising the use of a triangular impulse function. In some embodiments, the triagular impulse function has a width, W, wherein W is an integer selected from the range 2 to N, and wherein N is the monomer length of the polymer. In some embodiments, the PVDs have been normalized and rescaled prior to being simplified. In some embodiments, the values in the matrix are scaled by a parameter describing the one or more physical properties of the monomers that constitute the polymer. In some embodiments, the polymer is a protein. In some embodiments, X=3 and t=2.

In some embodiments, the method further comprises using PVDs constructed for all impulse function Widths, W, e.g., in the range 2 to N, wherein N is the monomer length of the polymer; and summing the resulting matrices a W-independent matrix (E-MAAP™). In some embodiments, the values in the matrix are scaled by a parameter describing one or more physical properties of the monomers that constitute the polymer. In some embodiments, the polymer is a protein.

In another aspect, the methods of the invention include identifying proteins that have similar structural folds, the method comprising: obtaining a first scaled E-MAAPTM of claim 43, wherein the E-MAAPTM is scaled, e.g., using amino acid cohesion energies; obtaining a second scaled E-MAAPTM of claim 43, wherein the E-MAAPTM is scaled, e.g., using amino acid cohesion energies, and wherein the polymer sequence of the second scaled E-MAAPTM is different from the polymer sequence of the first scaled E-MAAPTM; and determining the similarity of the second scaled E-MAAPTM with respect to the first scaled E-MAAPTM. In some embodiments, the second scaled E-MAAPTM is selected from a database of similar E-MAAPTMs. In some embodiments, the methods further comprise: repeating the method with the same first scaled E-MAAPTM but different second scaled E-MAAPTMs from the database, and optionally, ranking the E-MAAPTMs of the database with respect to their similarity to the first scaled E-MAAPTM.

In another aspect, the methods of the invention include estimating the folding rate of a protein, the method comprising: obtaining a scaled E-MAAPTM of claim 43, wherein the E-MAAPTM is scaled using the Richardson hydrophobicity scale; making a three-dimensional representation of the scaled E-MAAPTM; integrating the positive volume of the three-dimensional representation; and using the value resulting from the integration to estimate the folding rate of the protein. In some embodiments, estimating the folding rate comprises the use of an empirically determined mathematical equation that relates the positive volume of the scaled E-MAAPTM to the folding rate of the protein.

In another aspect, the methods include identifying positions of contextual similarity in a pair of polymers, the method comprising:

a) obtaining a first set of PVDs describing one or more positions in the first polymer and a second set of PVDs describing one or more positions in the second polymer, wherein the PVDs of the first and second set of PVDs have been simplified to include only X context leading monomers, and wherein X has a value equal to less than half the number of elements in a PVD that has not been simplified;

b) performing pairwise comparrisons of each PVD (CLXPVD) from the first set of PVDs with each PVD (CLXPVD) from the second set of PVDs, wherein two PVDs that have a threshold number, t, of CLMs in common are identified as representing monomer positions that are contextually similar, and wherein t is less than X; and,

c) optionally, generating a matrix (E-MAAPTM) representing the results of step (b), wherein each position in the matrix corresponds to the results of a single pairwise comparrison of PVDs, and wherein a value of “1” is assigned to positions in which the two PVDs are found to be contextually similar and a value of “0” is assigned to positions in which the two PVDs are not found to be contextually similar. In some embodiments, the PVDs have been generated by a method comprising the use of a triangular impulse function. In some embodiments, the triagular impulse function has a width, W, wherein W is an integer selected from the range 2 to Nmin, and wherein Nmin is the monomer length of shorter of the two polymers. In some embodiments, the PVDs have been normalized and rescaled prior to being simplified. In some embodiments, X=3 and t=2.

In some embodiments, the methods further comprising the steps: using PVDs constructed for all impulse function widths, W, in the range 2 to Nmin, wherein Nmin is the monomer length of the shorter of the two polymers; and summing the N−1 matrices resulting from step (d) to produce a W-independent matrix (E-MAAPTM). In some embodiments, the values in the matrix are scaled by a parameter describing one or more physical properties of the monomers that constitute the polymer.

In another aspect, the invention includes methods of predicting an interaction between two polymers, the method comprising: scaling the values of the matrix produced by the method of claim 43 using amino acid cohesion energies; and identifying positive peaks in the values of the matrix, wherein such peaks are indicative of monomer residues in the two polymers that are predicted to interact with one another.

In another aspect, the method of representing a polymer sequence, the method comprising: obtaining a PVD representing a position in the polymer sequence; and using the elements of the PVD to construct a Context Functional Surface (CFS) for one or more positions in the polymer sequence. In some embodiments, the PVD is normalized and rescaled. In some embodiments, the PVD has been generated by a method comprising the use of a triangular impulse function, and wherein the triangular impulse function has an optimized width. In some embodiments, further comprising base-line subtraction of the CFS. In some embodiments, the elements of the PVD are used to construct a CFS for all monomer positions in the polymer. In some embodiments, the set of CFSs corresponding to each of the monomer positions in the polymer are combined to generate a CFS having an additional dimension, wherein the additional dimension is along the monomer position coordinate. In some embodiments, the polymer is a protein.

In another aspect, the invention includes methods of characterizing secondary structure segments in a protein, the methods comprising:

a) obtaining a PVD representing a particular monomer position, R, in the protein, wherein position R is located within a predicted secondary structure segment in the protein, and wherein the PVD is normalized and rescaled;

b) using the PVD of step a) to generate a CFS for each monomer position in the polymer;

c) modifying the CFSs by base line subtraction;

c) plotting the positive values of the CFSs of step c) on a single graph to produce a G-profile; and

d) analyzing the G-profile to determine whether there are any islands that point to a monomer position P in the protein, wherein position P is not the same as position R, and wherein such islands are indicative of contextual similarity between the secondary structure segment containing position P and the secondary structure segment containing position R.

In some embodiments, the method is repeated using PVDs representing monomer positions located in each segment of predicted secondary structure. In some embodiments, contextually similar segments of secondary structure are further analyzed to determine whether they correspond to α-helical or β-strand types of secondary structure.

In another aspect, the methods of the invention include characterizing the contextual similarity of different positions in a polymer, the method comprising:

a) obtaining a PVD representing a particular monomer position, R, in the polymer, wherein the PVD is normalized and rescaled;

b) using the PVD to generate a set of CFSs for each position in the polymer;

c) calculating an N×N correlation matrix, r_{R}, for the set of CFSs generated in step b), wherein N is the number of monomers in the polymer;

d) repeating steps a) through c) for all positions, R, in the polymer, thereby producing N correlation matrices; and

e) using the N correlation matrices of step c) to generate a GCD for the polymer.

In some embodiments, the PVDs have been generated by a method comprising the use of an impulse response function having an optimized width. In some embodiments, the CFSs are modified by base-line subtraction prior to being used to calculate the correlation matrices. In some embodiments, the method further comprising normalizing the elements of the GCD. In some embodiments, the polymer is a protein.

A method of identifying contextually unique positions in a polymer, the method comprising: obtaining a GCD for the polymer; and identifying elements in the GCD that are greater than or equal to a predetermined threshold value; and identifying correlated islands in the set of GCD elements identified as exceeding the threshold value.

A method of predicting the effects of mutations on the structure of a protein, the method comprising:

a) obtaining a GCD for the protein;

b) identifying a position P in the GCD which corresponds to a point having maximal value in the GCD;

c) identifying a position R in the GCD having second maximal value within the row vector of position P of the GCD;

d) plotting the row vector of the GCD at position P and the column vector of the GCD at position R on the same graph; and

e) identifying peaks in the graph,

thereby identifying positions in the protein that are predicted to disrupt the structural stability of the protein when mutated.

In another aspect, the invention features a method of identifying positions in a nucleic acid sequence, the method comprising:

a) obtaining a GCD for a protein encoded by the nucleic acid sequence;

b) identifying a position P in the GCD, e.g., which corresponds to a point having maximal value in the GCD;

c) identifying a position R in the GCD, e.g., having second maximal value within the row vector of position P of the GCD;

d) plotting the row vector of the GCD at position P and the column vector of the GCD at position R on the same graph; and

e) identifying regions in the graph, e.g., peaks or troughs, corresponding to positions in the protein that are predicted to have an impact, e.g., strong or weak impact, upon the structural stability of the protein when mutated; and

f) identifying regions of the nucleic acid sequence that encode amino acids corresponding to the positions, e.g., peaks or troughs, in the graph of step e),

thereby identifying positions in the nucleic acid sequence that are likely to contain SNPs.

In another aspect, the present invention comprises databases comprised of novel representations and treatments of sequence data that will be useful for analyzing a particular polymer sequence. These informational databases have applications in, for example, drug discovery, genomics, and bioinformatics.

The methods of the present invention are directed to extracting novel and non-obvious, biologically relevant information (e.g., structural, functional, therapeutic) from the primary structure of biopolymers, particularly proteins. The methodology is completely general and can be applied to the analysis of the primary structure of any polymer that can be characterized by a primary structure (i.e., the known order of a limited set of chemically distinct monomers that are covalently bonded into a linear, un-branched polymeric molecule). Thus, specific and important examples of polymers other than proteins that can be analyzed using the methods of the invention include proteins containing non-naturally occurring amino acids, DNA, RNA, modified nucleic acid molecules, peptide nucleic acid molecules, etc.

In many aspects, this extraction of biologically relevant information using the methods of the invention is independent of any additional information about the relationship between the primary structure of the polymer and biologically relevant information known for other polymers (e.g., characterized proteins). In contrast, existing approaches used to find relationships between the primary structure of a polymer (e.g., a protein) and biologically relevant information are heavily biased towards similarity-based methodology (i.e., identifying another polymer that has a similar primary structure and known three-dimensional structure and/or known function, and transfering such information to the unknown polymer).

For example, the primary structure of a uncharacterized protein can be checked by sequence alignment methods against the primary structures of other proteins described in databases (e.g., Protein Data Base, SwisProt, etc.) for high sequence homology(ies). If (high) homology is found, any biologically relevant information associated with the protein in the database becomes associated with the uncharacterized protein, with the result being subject to experimental verification. In this way, proteins can: (i) be assigned to a specific 3-D fold type; (ii) be assigned to a specific functional class of enzymes; (iii) be assigned to a specific biochemical pathway; (iv) have active site residues identified; and (v) have sites of inter-molecular interactions (e.g., protein-protein, protein-DNA, protein-lipid) identified.

The current methods attempt to do generate similar information (and more) without much reference to external databases. It is possible because it relates to the mechanism by which the biological activity of a biopolymer is encoded in the gene, transcribed into the polymer primary structure, and then converted into the properly folded, active form. Based upon the novelty of the treatment of primary structure, the results can be completely unique and not obtainable from the current methods. Furthermore, the methods provide: (i) tools for selecting the right solution from multiple equivalent results obtained using the existing methods; (ii) reasonable starting points (initial estimates, boundary conditions, etc.) for optimizations, artificial intelligence, data mining methods, etc.; and (iii) mathematical descriptors of features of primary structure that are needed for quantification of relations between primary structure and biologically relevant information that cannot be derived from existing methodologies.

The methods of the invention relate to a paradox: proteins typically fold into three-dimensional structures very rapidly (e.g., in less than a second), uniquely, and in many cases reversibly. This cannot be explained by a “brute-force” sampling mechanism in which every one of the twenty chemically distinct monomers (i.e., amino acids) in the protein contact every other monomer and, based upon the energy of the resulting interaction, stay together or split up to probe another possibility. This process is combinatorially too complex, given twenty amino acid types and the typical protein length, to explain the observed folding rates. The question, then, is how to simplify the complexity of the folding problem?

Some useful considerations in finding an approach to the problem include:

(i) a monomer (e.g., amino acid) is not a unit of energetic information that is relevant for folding. Instead, groups of monomers are used to imprint an energy characteristic (“color”) to a primary structure segment.

(ii) there is only a certain number of energy states or “colors” along the primary structure that are necessary for the correct, unique, and rapid folding of a protein.

(iii) the energy state or “color” can be largely independent of the exact order of amino acids of the segment (otherwise, the alignment methods would already found the solution of the problem).

There is some non-obvious evidence that these founding principals are useful. First, the physical principles of intra-molecular interactions between amino acids (weak interactions) indicate that the stabilization energy has a strong dependence upon the distance between the interacting amino acid residues. Thus, the most important interactions are those between the closest amino acid residues. Second, the building blocks of protein structure are secondary structure segments. Local stabilization (e.g., by H-bonds) keeps secondary structure elements “rigid”, allowing the use of a “necklace” model of the protein with respect to the secondary structure segments already formed. Distance geometry theorem states that to define uniquely the three-dimensional structure of an assembly of N secondary structure segments, it is necessary and sufficient to fix six distances per segment. With two covalently fixed ends on each segment, to define the global features of a three-dimension fold it is necessary to further define four inter-segment interactions per segment. For globular proteins, this translates into identifying the 2N most important interactions. An analysis of the X-ray structures of 1000 non-homologous proteins shows that every secondary structure segment in a structure has, on average, two strong contacts to other secondary structure segments, which fits the 2N requirement for a well-defined three-dimensional structure.

Consider the features of regular secondary structures (e.g., α-helix and β-strand): assume that every α-helical segment can be characterized by three energy “colors” (there are 3 surfaces on each helix) and every β-strand segment can be characterized by 2 energy “colors” (there are 2 surfaces on sheet structure). The question is, given N segments, what is the number k of “energy colors” needed to partition uniquely the protein “necklace” so that the above distance geometry conditions can be met? The key to the solution is the uniqueness of the partitioning and the finiteness of k. Mathematical analysis show that for each N there is a unique solution of this problem.

The present invention provides for treatment of the full context dependence of monomer properties, including physical, chemical and biological properties, and considers contributions of each monomer, in the context of the entire polymer, to the overall property landscape of the whole polymer. The contextual analytical process is sufficiently robust to accommodate differences in the quality of quantitative descriptions of chemically different monomer units. Monomer residues are cast into a family of novel functional descriptors that enable enhanced similarity searching in diverse homomolecular and heteromolecular comparisons.

In the present invention, the behavior of each monomer is considered to be dependent on the integrated combination of the identities of all monomers, composition of monomer types, and the arrangement or order of all other monomers surrounding or connected to it contiguously via the polymer chain. As used herein, this integrated combination of sequence dependent effects is defined as the “context”. This concept of context is depicted in FIG. 1. The context provides a tool to extract maximum information content from a linear array of chemically linked monomers.

The use of monomer context to represent and analyze the properties of polymer sequences offers a number of advantages over the methods of the prior art. For sequences of unknown structures that show high homology with reference sequences having known structures, the contexts of the sequences and the reference molecules are very similar, as simply dictated by the alignment and corresponding high homology. Even in these cases, though, the invention provides quantitative tools, describing the context of each monomer in the sequence, which are useful for explaining the properties of the polymer (e.g. protein stability) and, thus, go far beyond the identification of fold type and/or related function. Furthermore, because of the lack of dependence on external information, the present invention provides important and useful information when there is no relevant reference information available for comparison. The present invention provides a substantial advantage in comparisons of sequences with little sequence homology with each other or reference sequences, but whose structures have high structural similarity, due to structural instructions encoded in sequence context. While not wishing to be bound by theory, it appears that high context homology belies high structural homology, even though there may be little actual sequence homology revealed by application of current alignment methods. Inability to effectively compare sequences with low sequence homology represents a major weakness of current alignment approaches, and the ability to determine important sequence information in the absence of sequence homology represents a major advantage of the present invention.

An important aspect that distinguishes the present invention from current methods relates to the following quandary. If essential molecular information is contained in the mere ordering of monomers along the linear chain then current methods of primary structure comparison analysis would be capable of decoding this information completely and, for example, determining the three dimensional tertiary structure of a protein from its amino acid sequence alone. To date, this capability has not been realized. The present invention extracts additional vital information present in biopolymer sequences, which cannot be decoded using simple alignment-based methods. A significant portion of this encoded information is contained in the relative frequencies and positions of different subsets of monomers in different regions of the linear polymer sequence. In this way key energetically desirable situations are generated that must arise from context dependent modulation of monomer energies that depend on the integrated influence of order, composition, and identities of monomers for the final structure and function of the protein. The present invention thus provides a more diverse, generalized set of tools for determining sequence-dependent polymer properties in which all three aspects of the context are considered in a balanced and integrated fashion. Comparison of two protein parts (in the same protein or different proteins) can be made that reveal a given set of monomers that reside in a specific similar (or dissimilar) context which, in turn, are shown to have distinct structural/functional properties.

The present invention can be used for the analysis of any linear array sequence of a polymer to elucidate features characteristics of sequence context. The primary structure of a particular polymer (i.e., the sequence of monomers) is the only input required. In this novel approach a particular position, in any string of monomer units comprising the primary sequence of any linear array polymer, is represented as a two (or more) dimensional vector (or surface) whose contour and related properties are determined by surrounding sequence context in its entirety. Relationships between sequence context and long-range interactions between sub-segments in a linear sequence are considered explicitly and thus, the present invention provides a method of decoding important useful information inherent in sequences. The present invention also provides tools for creating or designing linear arrays of monomer units having predefined, desired properties.

The present invention offers numerous benefits and advantages, as will be appreciated by those of ordinary skill in the art. The present invention provides a robust and consistent method for locating non-contiguous sequence components that form active sites in three dimensional enzyme structures. The present invention permits identification of permissive mutations, i.e. those mutations that do not kill the organism but induce changes in biological activity, such as mutations in p53. The present invention permits identification of regions conserved through evolution. The present invention allows identification of mutations that lead to drug resistance, for example, mutations in HIV protease sequence that correlate with drug resistance. The present invention allows for identification of circular permutation of protein ends, for example RNAse TI. The present invention provides methods and databases for the prediction of critical interactions involved in biological pathways. The present invention embodies a novel approach for protein engineering by context matching of super-secondary structures, and provides a means to generate the Cα distance map of folded proteins.

In other embodiments, the present invention provides analytical methods for DNA sequence analysis. For example, the present invention provides methods that use context correlations to identify gene, non-gene, and genetic regulatory regions. In addition, the present invention provides a means for decoding context dependent characteristics of gene sequence important for function. The present invention can also provide rules for interactions of DNA with ligands (proteins, drugs, etc.).

In addition, in the method of the present invention, sequence comparisons and searches for correlations are made by quantitative comparisons of context functional descriptors generated for protein and DNA sequences. Interactions between two types of molecules can be elucidated by these comparisons because the descriptors are generalized in an analogous way for both polymer types and encode essential molecular energetic features in them and thus are directly comparable.

### BRIEF DESCRIPTION OF THE DRAWINGS

FIG. 1 depicts the three constituent components of context. Any linear array constructed from a set of monomer units has inherent sequence-dependent contextual properties and information. These properties are manifiested in the primary sequence. For example, as shown, a polypeptide sequence comprised of amino acid monomer units can be analyzed and the ensemble of interelated contextual properties of the sequence (composition, order, and frequency) extracted by unique representations of the sequence. Such representations are used to determine structure/function properties of the final three-dimensional form of the polypeptide chain.

FIG. 2 depicts the generation of functional descriptors (FDs) for a polypeptide sequence. A polypeptide sequence of length N is shown circularized so that the C and N termini are connected. A functional descriptor is constructed to determine and represent the affect of the global context properties of the entire chain on each amino acid position along the chain, P_{N}. A uniform triangular impulse function is applied at every monomer position P_{N}, as shown schematically by a filled triangle for selected P_{N} along the chain. The impulse function measures the response of P_{N} to the global context properties. For example, the triangular impulse will have a baseline threshold as well as a symmetric descending scale whose maximum value is 1.0 and minimum value is the threshold. That is, the maximum value is centered at each P_{N} and uniformly descends down along both sides of P_{N} as one moves further out into the chain probing positions neighboring P_{N}.

FIG. 3 depicts the construction of a PVD. Each position along the polypeptide sequence shown is cast into a positive vector descriptor representing the response of position P to the ensemble of sequence dependent context properties. This vector is call a PVD. The PVD is constructed by evaluating an FD for each monomer position in the polymer sequence with respect to P. The vector at each position P is a 20×1 column vector, whose elements, Pᵢ (i=1-20), are evaluated using Equations (1) and (2) from the text. The row elements, i=1-20, are assigned to specific monomer identities and together contain the cumulative values of the FD_{P}s calculated for all of the monomer units surrounding P.

FIG. 4 depicts a hypothetical three-dimensional representation of a protein PVD Database. The horizontal axis is the amino acid index 1 through 20 as shown in Table 1. The vertical axis is the calculated value of the PVD determined from the product I*D*F as shown in FIG. 3. The third dimension (emerging from the page) is the amino acid position P=1-N. Each position P will have a distinct and likely unique PVD.

FIG. 5 depicts a hypothetical Leading Context Monomer Distribution Map (LMDM). The monomer identity of the context center is plotted versus the actual sequence and position in a portion of a hypothetical protein chain. The circles denote the context leading monomers (CLM). From the PVD at each position in the chain the identity of the amino acid having the largest value is determined and demarked. For example in the PVD of position 10 the element with the largest value corresponds to the amino acid V. This is also the situation at position 11. At position 12 the largest element is D. Moving along the sequence when the identity of the CLM changes, different context centers (CC) emerge. However, at certain positions, for example position 15, the identity of the largest element in the PVD at the position is also the actual identity of the amino at position 15, denoted by an X placed through the circle. This is termed a true context center (TCC), as described in the text.

FIGS. 6A-B depicts context leading monomer distribution maps (LMDM) for myoglobin (A) and HIV protease (B). The chemical identity (index or catalogue representative) of the monomer unit that is the CLM (the monomer whose element of the respective PVD is the largest value) is plotted versus primary sequence position, P=1 to N. In (A) there are 153 positions (the protein is 153 amino acids long), while in (B) there are 99 positions (the protein is 99 amino acids long). Circles denote context centers (CC), as described in the text, and the numbers indicate amino acid residues that are part of the context center, typically an amino acid residue that is a true context center (TCC).

FIGS. 7A-C depict LMDM for three proteins: (A) Protein G IgG-binding domain III; (B) the DNA binding domain of p53; and (C) myoglobin. The actual sequence is shown below the LMDM for Protein G IgG-binding Domain, and the secondary structure boundaries as determined from the LMDM are indicated on the protein crystal structures for protein G IgG-binding domain III and the DNA binding domain of p53. For myoglobin, the rectangular boxes located below the LMDM indicate the secondary structure segments determined by using the DSSP method.

FIGS. 8A-B depict comparisons of the contexts of various yeast proteins to determine their propensity for interaction. (A) Plots of the minimum values in the different matrix versus sequence position for yeast protein APC11 with nine other yeast proteins. (B) Plots of the minimum values in the difference matrix versus sequence poisition for yeast CUP 2 with four other yeast proteins. The N_{A}×N_{B} difference matrices (D_{AB}) with elements Dᵢⱼ (i=1 to N_{A}, j=1 to N_{B}) were calculated by taking the sum of the squares of the differences between the corresponding elements of the PVD of protein A in position i and the PVD of protein B in position j. Positions with the most comparable patterns in these maps are most likely to interact.

FIG. 9 depicts the method of locating positions of similar context in a polypeptide chain for the determination of protein fold subfamilies. Context similarity between any two positions i and j along an amino acid chain is defined using two parameters. The first parameter is the number of CLMs, X, found in CL_{X}-PVDᵢ and CL_{X}-PVDⱼ (i.e., the X largest values in the respective PVD's are used for comparison). The second parameter is the threshold number, t, where t is less than or equal to X. The threshold t, is the number of X whose identities are the same, between any two positions. The example is shown for three sequence positions, i, j and k. The parameters X and t are set to 3 and 2, respectively. Positions i and j are deemed not to be contextually similar because they do not have at least two CLM amino acid residues that are the same. Alternatively, i and k are contextually similar because two of their CLMs are the same (V and G). This process leads to construction of a context similarity scheme (CSS) map, as described in the text.

FIG. 10 depicts a calculation of the context functional surface (CFS) at position P of a polypeptide sequence. The CFS is a complete representative surface of the three components of context, determined with respect to a particular PVD (i.e., a particular context). To calculate the CFS, the PVD database is employed. Specifically, the diagram depicts the process of building a CFS function for the valine residue, which incorporates the order and content information of position 1 in the sequence (by using the elements (i.e., monomer values) of the PVD for position 1) and maps the frequency information about the individual monomer (amino acid) values. Construction of the two dimensional surface element for the central valine (V) at position P is shown. The first point in the CFS, at zero on the context coodinate is equal to the PDV₁ element corresponding to a valine. The next point, a, at 1 on the context coordinate, is the sum of the PVD element values from zero on the context coordinate (i.e., PDV₁(val)) and the PVD₁ elements corresponding to the amino acids neighboring the central valine residue (the threonine (T) on the left and the alanine (A) on the right). The next point, b, is constructed by summing the value of point “a” and the PVD₁ values corresponding to the identities of the next-nearest-neighbors of the central valine residue (the serine (S) to the left of threonine and the valine (V) to the right of alanine). The subsequent points c, d, e, etc. of the CFS are calculated in a similar manner, by moving out to the the next-next-nearest-neighbors of the central valine (the histidine (H) on the left of serine and the histidine (H) on the right of valine) and summing their corresponding PVD values (for position 1) to the value of point b, c, d, etc. The sequence of the protein is circularized for simplicity so that the ends do not have to be treated in a special way.

FIGS. 11A-B depict the global context signature for HIV protease. Shown in a three-dimensional contour plot (B) is the distinctive pattern that is formed by scaling the values of the E-MAAPTM with meaningful properties (e.g., physical, chemical, etc). For this example, cohesion energies were applied, as described in the text. Sequence position versus sequence position is plotted on the x versus y axis. The values in the contour slice shown in (A) correspond to the unscaled values for each pair of positions, as described in the text.

FIGS. 12A-B Utilization of the CFS to determine secondary structure identities in HIV protease. (A) Representative slices of the CFS at the same impulse width (W=30) for different positions along the protein. Similar patterns emerge for secondary structure segments of the same identity. (B) The book graph constructed from the knowledge of the secondary structure segments determined as in FIG. 6B and their relative identities from the plot in (A).

FIGS. 13A-E depict examples of the use of global context descriptors for determining active site regions in enzymes. Proteins analyzed include (A) HIV protease; (B) Alcohol dehydrogenase; (C) Myoglobin; (D) p53 DNA binding domain; and (E) photosynthetic reaction center.

FIG. 14 depicts a plot showing the predicted effects of mutations on protein function activity determined using the GFD. The amino position of the sequence of RecA protein is shown on the horizontal axis. Intensities of the GFD are plotted versus position. Positions of high intensity show regions where mutations are predicted to effect RecA function. Peaks of lesser intensity and valleys correspond to positions where mutations are less likely to affect function.

FIGS. 15A-B depict the correlation between the positive volume of a GCS plot (scaled using Richarson hydrophobicity values) and folding rate constants for the proteins analyzed. Scaling was performed after the similarity of positions was determined from PVD elements, using (X,t)=(4,3).

### DETAILED DESCRIPTION

The present invention provides novel methods for representing the monomer sequence of a polymer and use of such representations to elucidate important information about the molecular behavior of the polymer.

As used herein, a “polymer” is defined as a linear array of monomer units, including natural and synthetic monomer units. Natural polymers, sometimes referred to herein as biopolymers, include proteins, polypeptides, DNA, RNA, genes, gene fragments, nucleic acid oligomers, carbohydrates, and the like. Thus, in one aspect, the present invention is directed to the analysis of biopolymers. Biopolymers are molecules ususally having biological function that can be produced naturally (i.e., within a biological organism). Biopolymers are composed of a finite number of contiguous monomer units. For example, in the case of nucleic acid biopolymers, the monomer units are the naturally occurring nucleic acid residues (deoxyadenosine, deoxyguanosine, deoxycytidine, and deoxythymidine for DNA, or adenosine, guanosine, cytidine, and uridine for RNA). In the case of polypeptide or protein biopolymers, the monomers typically comprise the 20 standard amino acid residues (see Table 1). In another aspect, the invention is directed to the analysis of synthetic polymers. In contrast to natural polymers, synthetic polymers can contain one or more non-naturally occurring monomers. For example, for nucleic acids, non-naturally occurring bases can include inosine, peptide nucleic acids, etc. For proteins, non-naturally occurring amino acids can include cyclo-alkyl amino acid analogs, and the like. The term synthetic polymers also encompasses hetero-polymeric synthetic polymers comprising one or more types of monomeric repeating unit such as vinyl, polyalkylene glycols, etc.

The biological activities of biopolymers are conferred by their secondary, three-dimensional tertiary and quaternary structures. The chemical and physical features of the structures of biopolymers mediate their involvement in critical biological processes, such as molecular recognition, enzymatic catalysis, cell-cell recognition, molecular interactions in metabolism pathways, immune responses and biological infrastructures (i.e. membranes, tissues, etc.). The chemical and physical behaviors of individual monomers in a biopolymer are intrinsic to the penultimate active molecular structure (secondary, tertiary, quaternary) required for the biological activity. At the most basic level, the three-dimensional tertiary and quaternary structures of biologically active polymers emerge from their primary sequences through the proper spatial arrangement of their constituent monomer components. The three-dimensional tertiary and quaternary structures are energetically stable configurations that facilitate interactions between different molecules, including smaller molecules, ligands, and other biopolymers.

Since functional molecular configurations and structural conformations of biomolecules form from a limited set of monomer units, with individual molecular properties (chemical, physical, structural), the arrangement, composition and ordering (context) of monomers can provide a potentially infinite set of energetic states, although only a finite number of these are actually required for function in biological processes. The linear ordering, identity and composition of monomeric building blocks for a given polymer defines precisely the context in which a given monomer resides, and ultimately behaves, in the global context of the final active polymer. Linear ordering, identity and composition of monomer units also defines the contexts of sub-sequences of monomers and how these sub-sequences influence energetic contributions of each monomer to the energetics of the entire polymer. In essence, within the fixed linear arrangement of monomer units in polymer chains, there must exist instructions that properly link properties of monomer components with secondary, tertiary and quaternary structures required for functional activities, such as biological or enzymatic activities. In this way the arrangements of monomers, their type and relative composition (context) ultimately define the activities of the polymer chain.

The primary sequence of any polymer, whether a biological poloymer or synthetic polymer, can be described by the context concept. The present invention provides a focused treatment of individual components of context, in a global picture. Composition dependent context is explicitly considered in the inventive approach. That is, structural characteristics might depend on the number of a certain type of monomer (e.g., amino acid or nucleic acid residue) within a localized region of the sequence. Obviously, such effects are diminished with the attenuation of the particular properties of that monomer when its frequency within a given sub-region of the entire chain is lowered. Alternatively, a greater abundance of the particular monomer or a smaller set of monomers within a localized region can accent the composition dependent properties the monomer. Such sensitivity is due to the influence of the entire contextual environment on the local physical properties of the amino acids.

In some embodiments, the present invention can assay the linear array of amino acid residues corresponding to the primary structure of a protein. The set of individual amino acid residues that comprise the linear array are collected from a finite set of possible amino acid residues, which is the set of monomer units from which the polypeptide sequence can be built (e.g., the standard set of twenty amino acids, as shown in Table 1). For example, consider a single serine monomer (a polar amino acid) surrounded locally by monomer residues whose predominant physical/chemical nature is mostly hydrophobic. In such a situation, attributes of the neighboring hydrophobic monomers oppose and can diminish polar properties of the local region. But the modified polar properties of this local region can be essential for the final overall context environment necessary and required for stability of the final three-dimensional tertiary structure. Mere consideration of monomer composition from their order and frequency neglects the likely potential for overall contributions of individual parts of segments to the final structure and properties of the folded chain.

In another example, consider the following sequence of amino acids (in the single letter code): S-A-T-A-S-H-S-T-V-A-V-H-H-S-H-S (SEQ ID NO:1). There are three Alanine (A) residues, two Valine (V) residues, four Histidine (H) residues, two Threonine (T) residues and five Serine (S) residues. In terms of the chemical characterization, the monomer content of this sequence is comprised of five hydrophobic units (3A & 2V), seven polar units (5S & 2T) and four charged units (4H). The number of each individual amino acid in a polymer string defines the frequency. The precise arrangement of the units in the string is also important and what monomer units are linked to other monomer units must be considered. For example, in the sequence order given in SEQ ID NO:1, the first T encountered has two A residues for neighbors, two S residues as next-nearest-neighbors, etc., which defines the context of T.

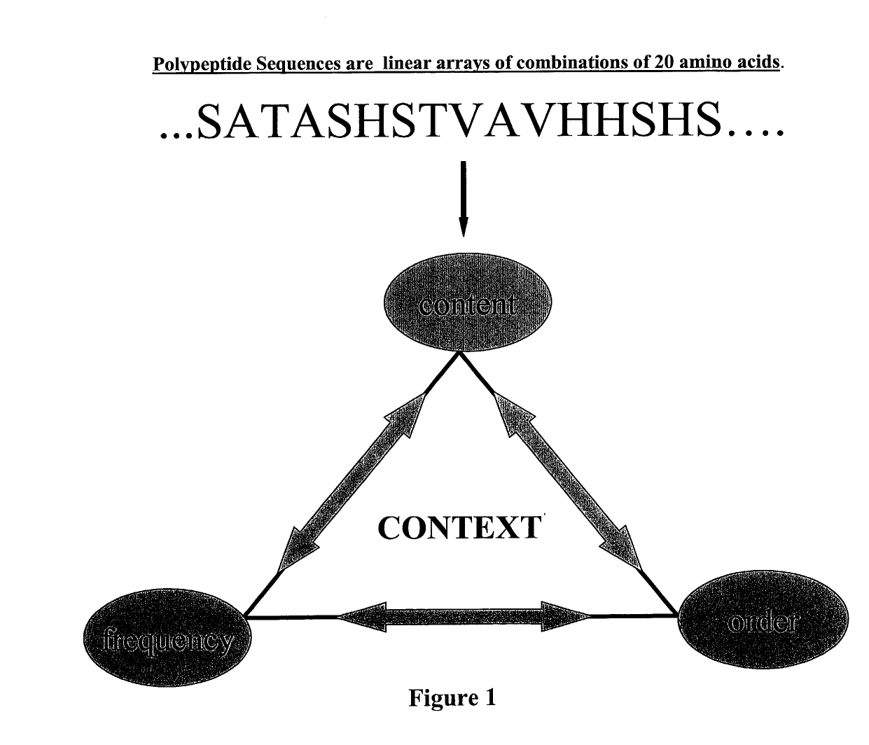

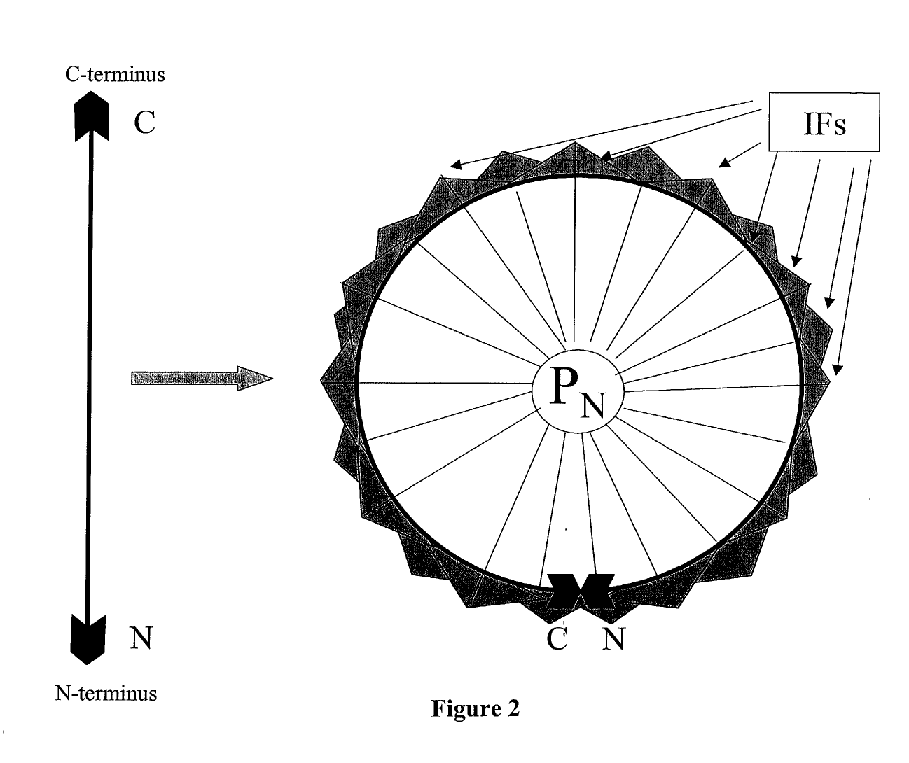

Interrelated features of sequence context (composition, frequency and order) determine the final three-dimensional structure of a polymer. FIG. 1 symbolically represents this trilogy of sequence features. FIG. 1 represents one embodiment of treatment of these properties to define and interpret the overall global context of the whole polymer chain. From this analysis, important information about the final biopolymer can be extracted from the primary sequence alone, and important, novel insight into biopolymer structure and function can be obtained.

Sequence Representations

The methods of the invention begin with a linear sequence of continuously linked monomers (naturally occurring polymers or biopolymer, synthetic polymers, and the like). For a polymer having N monomers, each monomer position in the chain is assigned a designated position index, P=1 to N. To avoid potential loss of information due to end effects, the polymer chain can be modified. In the examples that follow the chain is circularized (see, for example, FIG. 2). Alternatively, the polymers ends can also be treated as dummy (meaningless) monomers added to the ends of the actual polymer sequence. From a practical standpoint, circularization of the polymer sequence serves to avoid potential loss of information about the ends and can simplify the algorithms. For demonstrative purposes, consider the chain of linked monomers to be a protein chain comprised of monomers from the set of 20 amino acids. Each of the 20 amino acids is assigned a number from 1-20. The assignment is for cataloguing purposes and thus can be arbitrary, e.g., based on the alphabetical order of the one-letter code for amino acids. Accordingly, Alanine can be assigned the number 1 and Tyrosine can be assigned the number 20. Although the numbering is arbitrary, once chosen, the catalog number designations for the monomers cannot be changed. In this sense, a different number represents each monomer and all the physical and chemical properties associated with it. Table 1 shows the amino acids and the number designations used in the examples described below.

TABLE 1

| Amino Acid | One Letter Abbreviation | FD cataloguing number |
|---|---|---|
| Alanine | A | 1 |
| Cysteine | C | 2 |
| Aspartic | D | 3 |
| Glutamic | E | 4 |
| Phenlyalanine | F | 5 |
| Glycine | G | 6 |
| Histidine | H | 7 |
| Isoleucine | I | 8 |
| Lysine | K | 9 |
| Leucine | L | 10 |
| Methionine | M | 11 |
| Asparginine | N | 12 |
| Proline | P | 13 |
| Glutamine | Q | 14 |
| Arginine | R | 15 |
| Serine | S | 16 |
| Threonine | T | 17 |
| Valine | V | 18 |
| Tryptophan | W | 19 |
| Tyrosine | Y | 20 |

The Frequency Descriptor (FD)

For each monomer in a polymer chain, a Frequency Descriptor (FD) can be calculated with respect to any preselected monomer position, P, within the polymer. The FD is calculated as a general mathematical combination (e.g., product, convolution, sum, etc.) of functions that include: (1) a generalized description of the monomer content surrounding the preselected position, P (e.g., impulse response at each position of the occurrence of monomers in the primary sequence, percent monomer type, etc.); (2) a generalized function that considers the distance of the monomer from position P (e.g., inverse function of distance or any other type of distance function); and (3) a function which confers selected physical, chemical, biological, functional, or statistical properties of the monomer. A specific example is the generation of a set of FDs for an amino acid sequence. For each amino acid position, P, there is set of FDs (one for each monomer in the sequence) that describe the entire polymer context as it relates to that position. It will be clear to those skilled in the art that any number of known functions could be utilized to calculate an FD.

For example, the generalized description of monomer content (function (1) above) could be a triangular impulse function y(P), having width W and a maximum positioned at the preselected (or reference) monomer position, P. The impulse function can consist of a triangular function sitting on a baseline, with the baseline set to zero outside the window or, preferably, with the baseline set to a nonzero constant outside the window. Use of a nonzero constant outside the window allows for the consideration of the influence of all amino acids in the sequence, not only in the specified window. Furthermore, the baseline need not be constant. In some embodiments, impulse values are assigned according to a triangular Impulse window, along a uniformly delineated relative range, decreasing in value from 1.0 to 0.01 within the distance W/2 (½ the width of the window W), and outside of the window the baseline is constant and set to 0.01. The impulse function can have many different forms, including linear, exponential, oscilatory (e.g., sine or cosine), a constant value, or combinations thereof. An impulse function can be applied to describe monomer (e.g., amino acid, nucleic acid) sequences, leading to the generation of an Impulse Response Function (IRF). An IRF can be calculated for each position in a polymer and provides an explicit quantification of the context at each monomer position. Resolution can be tuned by adjusting the window size, W, when calculating the set of FDs related to each preselected position, P. FIG. 2 depicts a circularized amino acid sequence with impulse functions having a window size of 20 monomers.

With regard to the distance function (function (2) above), the distance dependence of the influence of a monomer on position P, f(dP(j)) j=1, . . . , N, can be defined as 1/dP(j)), where d is the number of monomer positions away form P that a particular monomer residue, j, resides. Thus, if a particular monomer residue, R, is three positions away from P, d=3 and the distance function will have a value of ⅓ for residue R when calculating the FD with respect to the monomer at position P. Other forms of the distance function are possible, including linear, exponential, oscilatory (e.g., sine or cosine), or combinations thereof. In general, the distance function should be decreasing, with the exact mathematical form reflecting the rate at which the contextual importance of a monomer decreases as its distance increases from a monomer at position P. For example, distance functions for biopolymers (e.g., globular proteins) might be oscillating (e.g., quasi-periodical), since monomers far away from P in primary structure might become close to P in the folded structure, thereby influencing the context at P.

For a function describing the properties of a monomer (function (3) above), any suitable function ℑ(m, P), where m represents each monomer type (e.g., for proteins, m=1 to 20) and P=1 to N, can be defined depending upon the parameter of interest, e.g., polarity, hydrophobicity, monomer volume, etc. This “property” function is a reflection of the chemical identity of a monomer at any position. For example, the property function can provide a hydrophobicity value for a monomer, such as alanine, tryptophan, etc. Alternatively, the property function can relate to the propensity of a monomer to form a helix, the cohesion energy of a monomer, or the frequency with which a particular monomer appears in cancer-related mutations. Essentially, any known, measured or desired property of the monomers can be incorporated in the methods of the invention through this function. Some suitable functions/properties have been discussed, e.g., in A. Kidera, et al. (1985) “Statistical Analysis of the Physical Properties of the 20 Naturally Occurring Amino Acids”, J. Prot. Chem. 4:23-55. Finally, the value of the function can be set to 1, such that no specific physical/chemical properties are being considered.

In the examples discussed herein, the three functions of the FD are combined by multiplication. The calculation is carried out for each monomer with respect to a preselected monomer position, P, resulting in N calculations of the FD. The resulting FDs for each P are stored in a database. For complete treatment of the polymer of interest, the calculations can be carried out wherein each monomer position is chosen as the preselected monomer, thus resulting in N² calculations of the FD.

In some embodiments, the FD at each position is calculated according to,

FD_{P}=I*F*D (1)

Where I is a term in the IRF that defines the frequency property of the sequence surrounding the monomer at each position P; D defines an adjustment (a penalty) for contributions from any given monomer far away from P to the contextual characterization of P, wherein D is treated as a simple weighting function of the form,

D=1/d (2)

and F is a term that allows one to link specific sequence dependent properties of P with surrounding monomers. The F values can be monomer property matrices, i.e., sets of values assigned to each monomer, which are characteristic of physically or chemically measured quantitative monomer (e.g., amino acid or nucleic acid) properties. Thus, F can be used to treat, in a specific manner, the identity or content of the sequence in the entire chain surrounding P. It is important to note that the FD_{P} for the refernce monomer, P, is a special case and is equal to I*F (i.e., the D term is omitted).

The Position Vector Descriptor (PVD)

For each position, P, in a polymer, a position vector descriptor (PVD) can be calculated. Each PVD serves as an alternative representation of the corresponding monomer, assembling the cumulative contextual information related to the monomer's position in the polymer sequence, and is defined by both the identity of the monomer and the contribution of all surrounding monomers to the context of the monomer, as quantified by the set of FD_{P} values of the surrounding monomers. If there are m types of monomers in a polymer, then each PVD will have m elements. For example, a PVD representing one monomer of a naturally occurring protein will typically have 20 elements, one element for each of the possible 20 amino acids that may be present in the protein. Elements of the PVD can be scalar (e.g., numbers), vectors (e.g., functions) or more complex mathematical structures (e.g., tensors, manifolds, etc), depending upon the details with which the contributions of monomers to the position context are needed for a particular application. The input for generating a PVD is the polymer sequence and all of the FD_{P} values relating to a particular position, P, in the polymer sequence. For a given position, P, the primary sequence is scanned one monomer at a time. At each position R (R=1 to N), the identities of the monomer at position R is recorded and the value of the corresponding FD_{P} (determined as discussed above) for the monomer is combined with the initial or previous PVD component corresponding to the same monomer. The PVD generation process continues until each monomer in the sequence has been represented in the vector. Alternatively, the process can be terminated with other suitable ending criterion (e.g., when all m elements of the PVD are first found to be non-zero, etc.). After termination of the cycle, the PVD array for each position can be further manipulated (e.g., normalized and/or rescaled, etc.) if desired and then stored in a database.

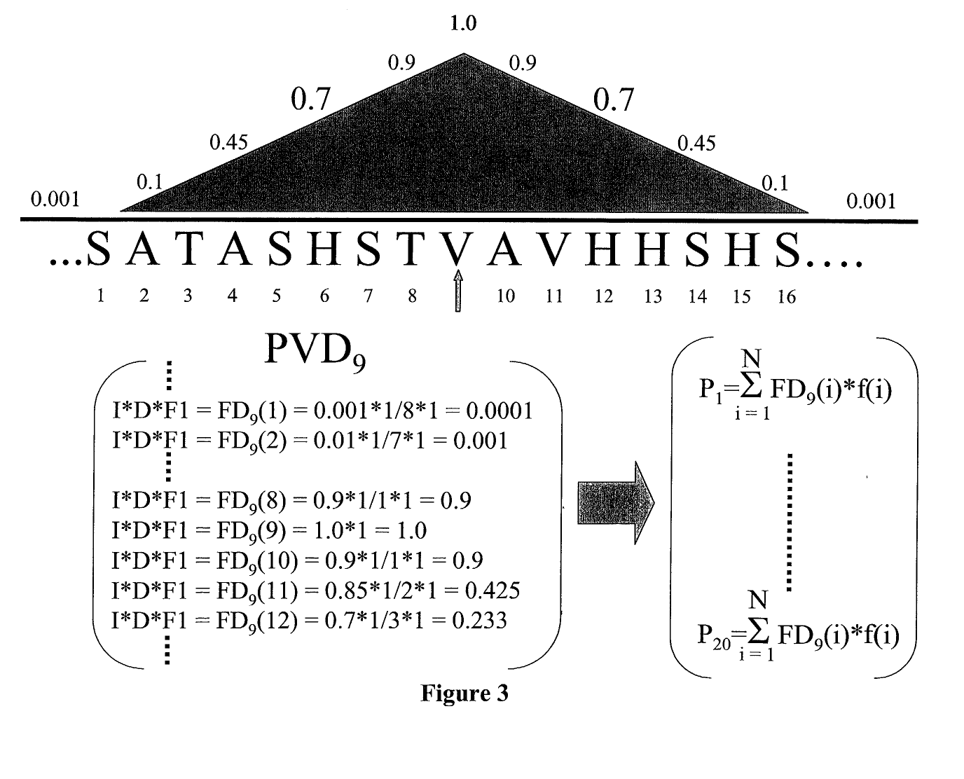

Shown in FIG. 3 is a hypothetical polypeptide chain and partial calculation of the PVD for the valine residue located at the center (see arrow). The PVD is constructed by evaluating an FD_{P} (where FD_{P}=I*D*F for all monomers other than the reference valine (FD_{P}=I*F for the reference valine), with the impulse function, I, having width W=15 and a linear declination from 1.0 to a baseline of 0.001, D=1/d, and F=1, as discussed above) for each amino acid in the polymer, and summing the contextual contribution of each amino acid type. The resulting PVD vector is a 1×20 column vector containing elements:

Pⱼ=Σ_{i=1 to N}FD_{P}(i)*f(i) (3)

where j=1 to 20 and corresponds to one of the possible amino acids, i=1 to N and corresponds to each of the residues in the polypeptide chain, FD_{P}(i) is the value of the FD_{P} at position i with respect to position P (in this case occupied by valine), and f(i)=1 if the amino acid at position i is the same as amino acid j, but f(i)=0 otherwise.

The PVDs for every monomer in a sequence can be used to make a matrix where each column (from i=1 to N) is the PVD for a monomer in the sequence. The row elements, j=1 to 20, are assigned to particular monomers and contain the cumulative values of the FD_{P}s calculated for the monomer units surrounding P.

For every conceivable protein or nucleic acid sequence for which a complete sequence exists in a database (e.g., PDB™, SWISSPROT™, GENBANK™, etc.) a corresponding set of PVDs can be generated and stored in a matrix representation referred to herein as an “Expressway Database”. A PVD can have elements that are scalars, as depicted in FIG. 3, or they can be matrices or multi-dimensional tensors, if a more complex form of probing function (e.g., an impulse train or more than one probing function, e.g., taper functions) is used to probe sequence context. Each protein will have a corresponding number of PVDs defined by the size of the polymer (i.e., the number of residues in the polymer). Thus a protein chain with 386 amino acids will have 386 PVDs, one for each amino acid residue in the chain. In some embodiments, each protein of N amino acid residues will have an N×20 PVD matrix. In some embodiments, depending on the particulars of how F and D are treated, different sets of PVDs can be generated for the same sequence, but the total number of PVDs will be the same, as dictated by the number of amino acid residues in the chain.

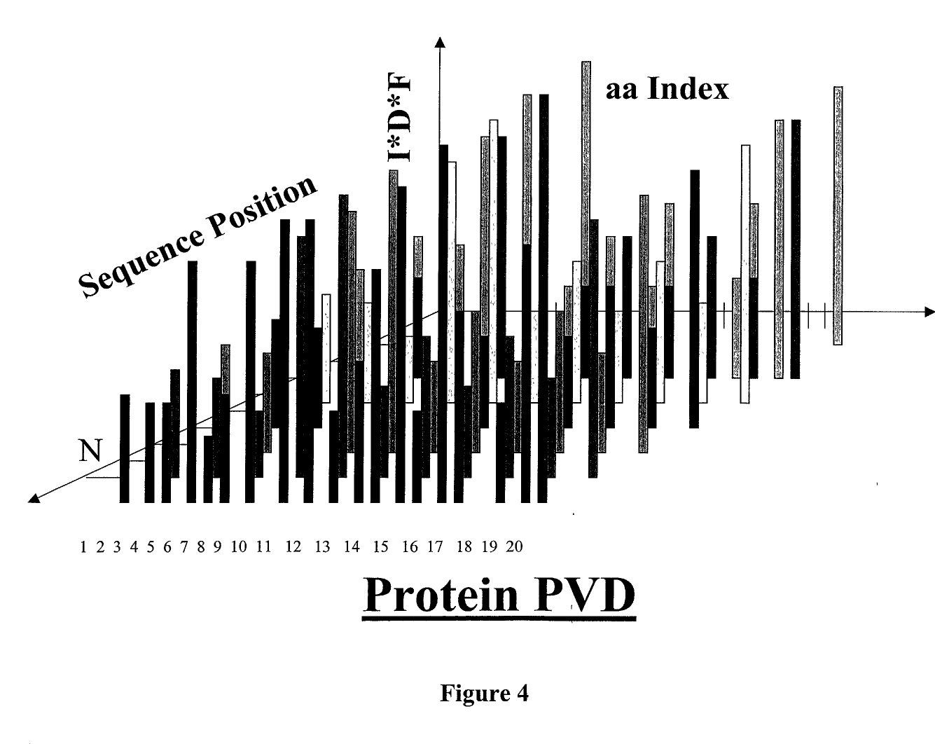

FIG. 4 is a graphical representation of a PVD database showing the elements of several (7) PVDs. The magnitudes of the elements in each PVD quantitatively reflect the contribution of chemically distinct monomers to the sequence context at a particular position. The element with the largest value in a given PVD dominates the sequence context at the corresponding momomer position. Likewise, the influence of the element having a minimum value in the PVD is least important for the sequence context in the corresponding monomer position.

One aspect of the PVD utility is that dominant context features in the chain are represented in a mathematically robust way (minima and maxima of the calculated FDs). Thus, the PVD representation provides important insight into the structural properties of a protein, as determined by the context each monomer of a polymer chain.

Quantification of Mutational Effects Using PVDs

In some embodiments, the methods of the invention include predicting the energetic effect of altering a particular monomer in a polymer using the PVD representation for the monomer. There are many experimental methods known in the art for analyzing the energetic effects of a point mutation on, e.g., a protein. Such methods include measurement of the temperature dependency of absorption spectra, calorimetry, etc. Until now, though, there are no general methods for predicting the energetic impact of a mutation on the stability of a polymer (protein). (Some publications use word “serendipity” to describe the state of art in mutation-stability explanations). The methods of the present invention thus represent the first systematic and general approach to this problem. The methods use quantitative description of context of every position in a polymer sequence, and quantitatively determined contributions from all monomer types to the context of a position as a basis for explaining the energetic changes caused by alterations (e.g., mutations) that effect protein structure and/or function. These methods can include the following steps:

A. Identifying one, two or more positions having point mutations in a polymer (e.g., a protein) where the effect of the mutations upon the stabilization energy of the polymer can be obtained or subsequently determined (e.g., by determining ΔΔGₘᵤₜ). For some applications, e.g., engineering higher thermal stability of enzymes, etc., the mutations should not drastically destabilize the folding of the polymer so that reliable measurements of the changes in folding energy can be obtained, Perhaps more importantly, the biologically active conformation of the enzyme should remain preserved, thus conserving the function of the mutated protein. This position identification can be done using context-based descriptors, e.g., Global Context Descriptor, central profiles or other variants of E-MAAPs, or some combination thereof, as discussed herein. Preferably, sequence positions where mutations are permissible are located in sequence regions with low global contextual importance, which can be quantified by the regions of minima in context-based descriptors. In other embodiments, e.g., when the goal of the mutation is to knock-out the function of the active form of the polyme, the selected positions will be in the regions of maxima of abovementioned context-based descriptors.

B. Calculating the PVDs for those positions in the polymer chain that include mutations. In preferred embodiments, the PVDs are determined using an impulse function having an optimal width (W). Optionally, the PVDs can be normalized and rescaled.

C. For each position corresponding to an analyzed mutant, determining the difference (Dₘᵤₜ(PVD)) between the value of the PVD element corresponding to the monomer present in the natural (i.e., unmutated) polymer and the value of the PVD element corresponding to the monomer present at the same position in the mutant polymer. For example, in Table 3 at position 1, the difference between the values of Asp and Phe is −0.1150−0.8520=−9670.

D. Generating a mathematical expression, e.g., by regression analysis, that relates Dₘᵤₜ(PVD) for each mutation and the corresponding effect of the mutation upon the folding energy of the polymer (e.g., ΔΔGₘᵤₜ). The mathematical expression can be linear, exponential, produced by a neural network, etc., and can be augmented, e.g., by context-based descriptors, e.g., Global Context Descriptor, central profiles or different variants of E-MAAPs, or some combination thereof, at the studied positions (these terms can be omitted if the selected positions of mutations are in the minima of the global sequence context, as described by these tools, because of the low dynamic range (nearly constancy) of the values that would be used. On the contrary, these terms should be included if the formulation (biology requirements etc.) of the problem requires selecting sequence positions with variable global contextual importance. Regression analysis is widely used in the art and can be performed in many different ways, any of which are suitable to the methods of the invention.

E. Using the mathematical expression of step D and a PVD corresponding to a position of interest, or preferably to each other monomer from a complete set in the same polymer, to predict systematically the energetic effects (e.g., ΔΔGₘᵤₜ) of introducing a particular mutation into the polymer at the site of the monomer of interest. The monomer of interest may or may not be at the same position as one of the altered monomers used to generate the mathematical expression.

Context Leading Monomers (CLMs)

Each element of the PVD for a particular position P uniquely and quantitatively measures the collective contribution of every monomer of a particular type (e.g., alanine, glycine, etc.) in the sequence to the context of the monomer at position P. Thus, the elements of the PVD collectively comprise the entire sequence context surrounding position P. By ordering the elements of each PVD according to their relative magnitudes, monomers are found whose collective contributions dominate the properties of sequence segments centered about P. Further, the element with the largest value in each PVD defines and identifies the monomer most important to the sequence context at that particular position. The monomer units with the largest values are termed the “context leading monomers” or “CLMs”. In some embodiments, the information encompassed in a PVD can be approximated or simplified by setting to zero all elements except the CLM. This step can be formally generalized to incorporate more than one element of a PVD as a CLM, to make a CLₓPVD. Thus, a CL₁PVD retains the single largest monomer element as nonzero, a CL₂PVD retains the two largest, and a CLₙPVD retains the n largest elements in the PVD as nonzero.

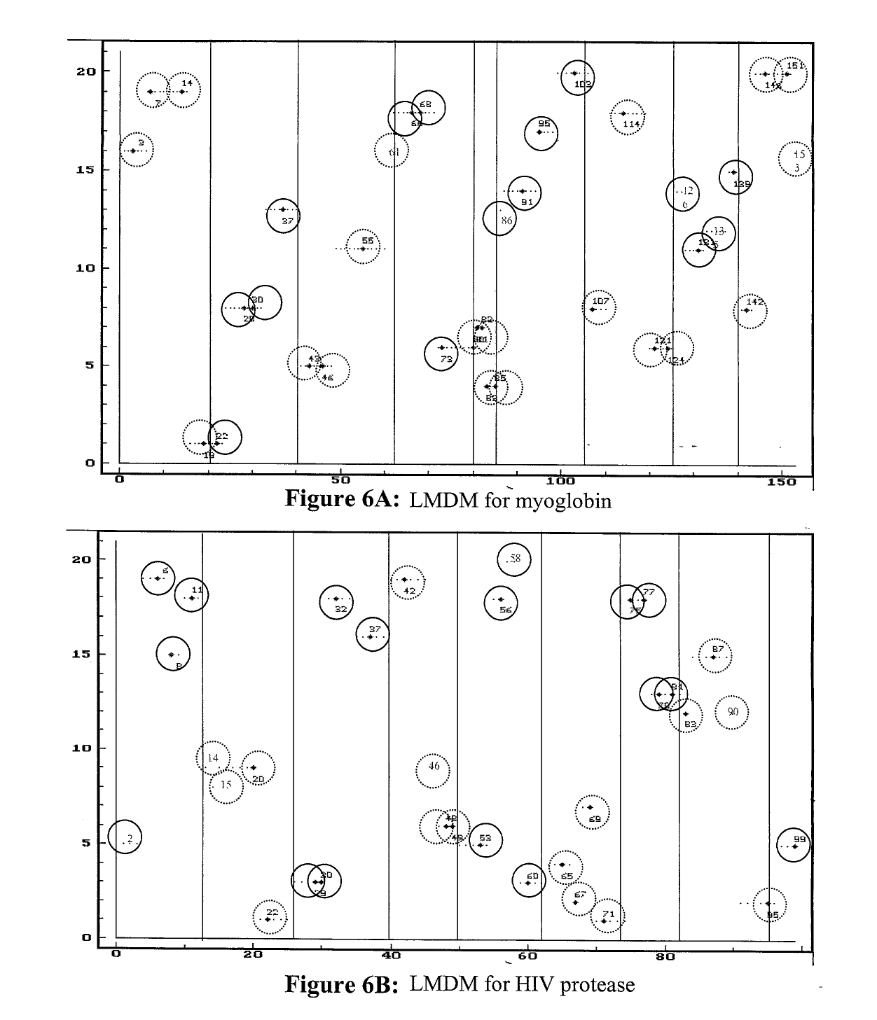

In some embodiments of the invention, a context leading monomer distribution map (LMDM) is constructed from a CLₓPVD. A LMDM can be constructed by plotting the chemical identity (or catalogue representative) of each monomer that is a CLM, versus position in the primary sequence. Such a map will have X+1 dimensions: X corresponding to the number of nonzero elements in the CLXPVD and one additional dimension for the primary sequence position. For example, a two-dimensional monomer distribution map has only the element with the largest value in the PVD plotted against sequence position. Two-dimensional LMDMs are shown for HIV protease and myoglobin in FIG. 6.

Elements of the PVD are the primary descriptors of the context at each P. The chemical identity of the CLM at any given sequence position, though, may not have the same identity as the monomer at the position in the actual sequence. Both cases (where the CLM is the same as the monomer in the actual sequence, and where the CLM differs from the monomer in the actual sequence) are important and influence structure/function interpretations based on the decoded contextual information of the sequence. For example, at some arbitrary position in a polypeptide sequence (e.g., P=100) there may be a histidine residue. The CLM for the PVD at position 100, however, may correspond to serine. This implies that the context of the serine residues present in the entire polypeptide is important and contextually most linked to position 100. This could reflect the fact that at short distances from the histidine at position 100, serines are frequently encountered. The importance of serine to the context of position 100 is irrespective of the fact that there is a histidine residue at that position. In other words, the order, sub-segment frequency, and total composition of serines along the polypeptide chain are most important to position 100, and thus encode important structure/function information related to the final folded structure adopted by the polypeptide sequence.

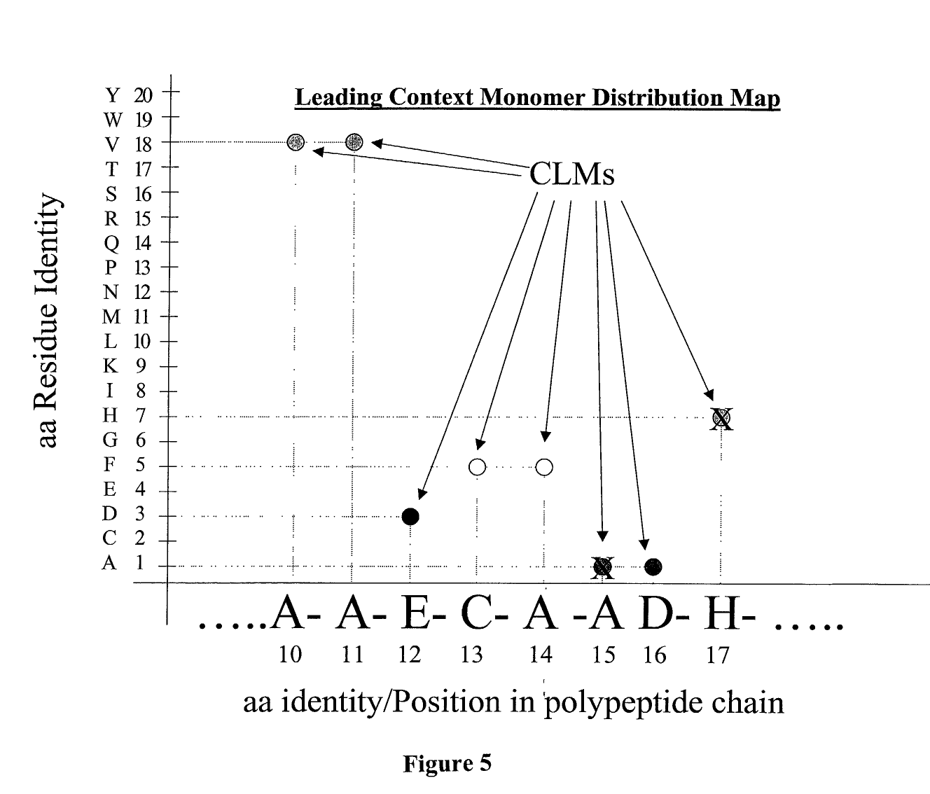

The LMDM for an entire polymer sequence (e.g., a protein) is typically comprised of sub-regions in which one particular monomer (e.g., amino acid) is the CLM for a contiguous stretch of monomer positions along the chain. These sub-regions are called context centers (CC). In most cases, the boundaries that contain the CLM until it changes monomer identity serve as the beginning and end points for the CC, and a new CC begins at a position where a new CLM appears. Special cases where the CLM is also the chemical identity of the monomer unit at position P are individually designated as true context centers (TCC). Thus, in the previous example, the histidine at position 100 would be a TCC only if the CLM at position 100 corresponded to the element histidine. FIG. 5 depicts a hypothetical LMDM. Five CCs are shown, as demarked by dotted lines. Two of the CCs include TCCs, which are marked with “x”s. If a TCC is embedded in a CC, then the TCC defines the context center for that stretch of monomers in the sequence. Thus, the number of context centers is five and the number of true context centers is two. If a stretch of monomers in a polymer chain contains one CLM, but within that stretch two amino acid positions corresponding directly to the identity of the CLM, then two CCs are present and both are characterized by a TCC (see FIG. 6; discussed more below).

PVD Optimization

When using an impulse function to calculate FD_{P} values and construct a PVD, the magnitude of the elements of the PVD will dependent on the width (W) of the triangular probing impulse applied to the sequence at position P. Any subseqent use of the PVD (e.g., to identify CLMs and construct a LMDM) will necessarily reflect the choice of W. Consequently, optimization of W is typically necessary to extract the most meaningful information about monomer context and make the most robust predictions about the structure/function properties of full length polymer. Optimization of W is performed for an entire sequence (e.g., for a set of PVDs representing the entire sequence) and can be accomplished by applying the following algorithmic procedure: adjustable parameters are optimized for a general function describing the length dependence of the optimal impulse width,

W=W_{∞}(1−ΣCₙ/Nⁿ) (4)

where W is the window size of the triangular impulse applied at each P, W_{∞} is the limiting window size of the probing impulse for an infinitely long polypeptide chain, N is the length of the sequence chain, W_{∞} and Cₙ are adjustable constants, and n is the order of the nonlinear dependence. This nonlinear dependence is necessary for optimal application of the impulse, and is determined empirically by least squares regression of the linearized form of equation (4) using data for proteins with known sequences and three dimensional structures. This optimization process uses existing X-ray structures from the Protein Data Base (PDB). From the primary sequence of the proteins, a W-dependent property, such as the location of secondary structure boundaries, is calculated for each W. The results are compared with the experimental observations and a W is chosen for each protein that best fits the data, e.g., the secondary structure boundaries determined from the X-ray structures. The resulting values of W and N for each protein can be used with equation (4) to determine the values of W, n and Cₙ by regression analysis. The best results are obtained by least-squares fitting of the log of equation 4. Another option is to use a different W-dependent prediction of a protein property (e.g. stability or drug resistance) that can be measured for a training set of proteins and will yield the W-optimization for predicting that particular biological property.

Alternatively, an optimal impulse width, W, can be calculated in the following manner: (i) for each W=2 to N, calculate PVDs for each monomer (e.g., amino acid residue) of a polymer; (ii) identify the CLMs of each PVD and generate an “effective primary sequence” for each value of W, wherein each position of the effective primary sequence is occupied by a CLM rather than the monomer (e.g., amino acid residue) of the natural sequence; (iii) calculate the number of identities in the alignment of each effective primary sequence with the natural polymer sequence; and (iv) plot the number of identities vs. the impulse width, W. The maximum of the plot produced in step (iv) is the optimal impulse width, unless the number of identities for the width is relatively small, in which case the second local maximum to the right (i.e., the second local maximum associated with larger impulse widths) is the optimal impulse width.

Obviously the probing pulse width (W) will affect which monomers have the largest PVD element values and thus whether they are designated as CLMs. Use of different probing pulse widths serves to probe different features of secondary structure compositions and higher order aspects of polymer secondary structure organization.

Secondary Structure Parsing

In some embodiments, the PVD database for a protein sequence can be used to locate secondary structure boundaries and looped regions, relying almost completely on the analysis of the primary sequence alone. The methods include the following steps:

A. Given a a protein sequence, calculate the optimal width of the probing impulse, e.g., using one of the methods described above. The optimal width, W, is then used to calculate PVDs for each amino acid in the sequence. For example, the PVDs can be constructed using the equations FD_{P}=I*D*F, where I is a triangular impulse function having width W, D=1/d, and F=1.0, as discussed above.

B. Determine the CLM (X=1) for each PVD, and construct a two-dimensional LMDM by plotting the 20 catalogued amino acid entries representing all 20 possible amino acids versus the sequence. The CLMs are denoted on the map.

C. Identify CC segments and TCCs on the LMDM.

D. Determine an integer value, Z, for the number of CCs/TCCs that define one (regular) secondary structure segment. In some embodiments, the determination is performed empirically, e.g., by comparing the LMDMs of proteins having known structures to the corresponding structures. Empirical studies have indicated that Z=4 is usually appropriate.

E. Starting at amino acid 1 of the protein sequence, count Z CC/TCC segments upstream and place a boundary line between the Z and Z+1 context centers. Then, starting at Z+1, repeat the process. The process is repeated until the end of the protein sequence is reached. The boundary lines correspond to predicted secondary structure boundaries.

In some embodiments, the methods of secondary structure parsing can be improved, e.g., by including more information from the PVDs or more empirical information. For example, two CLMs can be included in the LMDM. Since not all CLMs on a LMDM fall within a CC comprising two or more contiguous CLMs, inclusion of the second most contextually important monomer in the LMDM could indicate whether certain “singlet” CLMs belong in one of the flanking CCs.

With regard to the use of additional empirical information in the methods of parsing the secondary structure of polypeptides, it is reasonable to speculate that α-helical, β-sheet, and loop secondary structure elements may have certain classes which can be distinguished by number of CCs and CLM composition. By building a database of statistics describing the number of CCs and CLM composition of secondary structure elements in proteins having known structures, it should be possible to refine the rules for placing secondary structure boundaries. Thus, instead of counting Z CCs and placing a boundary, the methods could involve: (i) counting Z CCs; (ii) looking at the CLM composition of the Z CCs; and (iii) determining whether the empirical data supports a reduction, maintenance, or increase in the number of CCs that constitute the predicted secondary structure boundaries. Based on the CLM composition of the predicted secondary structural units, it could also be possible to identify what type of secondary structure element the predicted unit forms, e.g., α-helix, β-sheet, loop, etc.

Determination of Structural Homology Using CLMs

Since the set of PVDs for a given protein represent important contextual information that determines the structure and function of the protein, it is possible to use the PVDs or elements thereof (e.g., CLMs) to perform homology searches. Thus, in some embodiments, the “effective primary sequence” (i.e., wherein CLMs are used in place of the actual amino acid residues) of a protein can be compared to the effective primary sequences of other proteins, e.g., a database of proteins having known structures, in order to identify proteins having structural homology (i.e., the same structural fold). For example, the effective primary sequence of a protein can be used as the query sequence in standard homology searching and alignment algorithms known in the art (e.g., Blast, FASTA, etc.), wherein the effective primary sequences of other proteins are used as the database against which the query sequence is searched. Homology searching and alignment algorithms have been described in Needleman and Wunsch (1970), J. Mol. Biol. 48:443-53; Wilbur and Lipman (1983), Prot. Natl. Acad. Sci. USA 80:726-30; Altschul et al. (1997), Nucleic Acids Research 25(17):3389-402, the contents of which are incorparated herein by reference.

The methods of structural homology determination using CLMs can also be extended to the use of multiple (e.g. two, three, etc.) CLMs for each position in the effective primary sequence of the query protein. In such embodiments, the searching and alignment algorithms could be easily adapted to accommodate an additional step in which each element in the set of CLMs corresponding to a single monomer position in the query sequence is analyzed for identity with the residues of a database sequence (e.g., the effective primary sequence of a database sequence).

Prediction of Protein-Protein Interactions Using PVD Difference Matrices

While the PVD is clearly a representation of the sequence context for a particular monomer in a polymer chain, it can also be viewed as a representation of the energy state associated with the monomer. Thus, similarities in the context of two monomer positions can be used as an indication that the monomers have similar energy states and, e.g., are capable of physically interacting. Energetically stable interactions between two polymers or fragments thereof (e.g., two sub-domains of a protein or between two different proteins), however, usually requires a cluster of monomers (e.g., located on a common surface) in one polymer/polymer fragment to interact with another cluster of monomers in the other polymer/polymer fragment. Consequently, it is necessary to look at the contextual similarity of all pairwise combinations of monomers in order to make predictions about possible energetically stable interactions within or between polymers.

PVDs can be used directly to analyze the contextual similarity of a pair of monomer positions (and, hence, similarity of their energetic states of the monomers in them) by calculating the similarity or difference between two PVDs. For example, the difference between two PVDs (D_{A(j)B(k}), where A(j) is the PVD representing the jth monomer of protein A and B(k) is the PVD representing the kth monomer of protein B) can be calculated by summing the squares of the differences of the elements in each PVD:

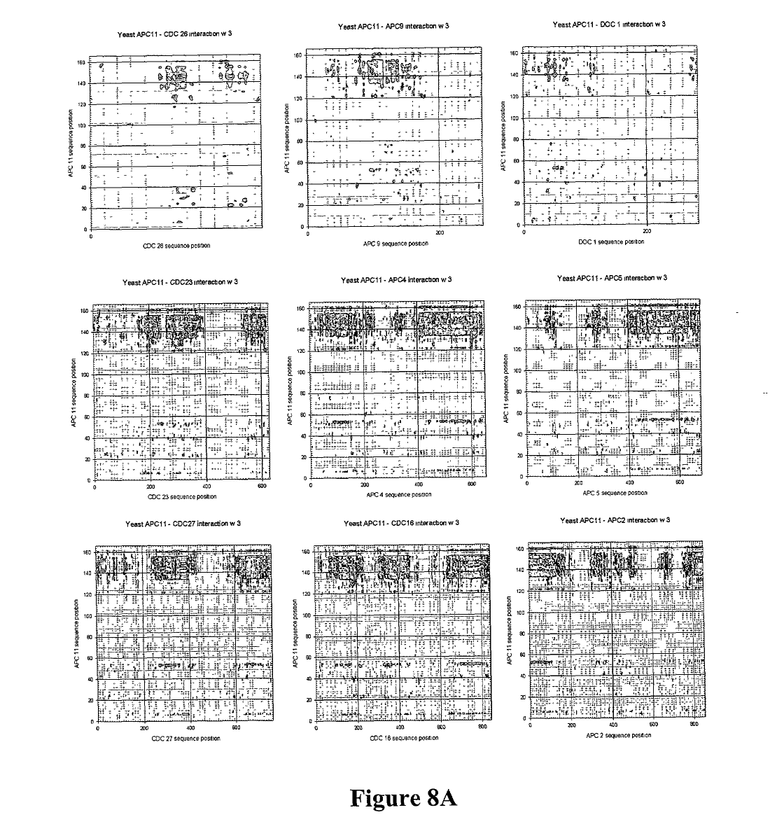

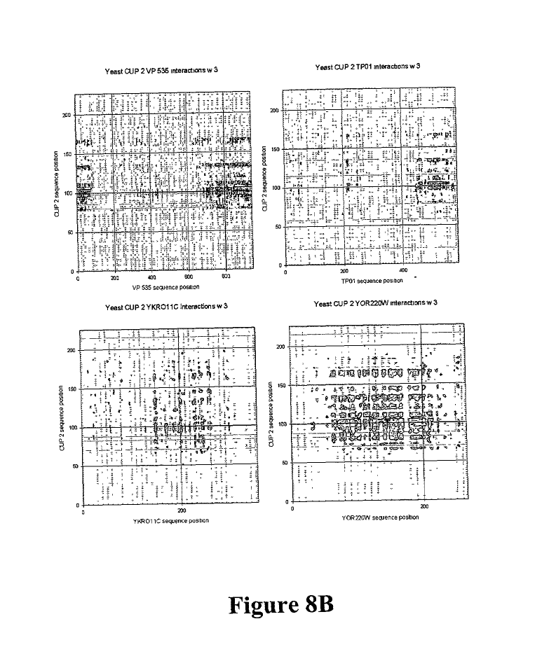

D_{A(j)B(k)}=Σ_{i=1toZ}(Aᵢ(j)−Bᵢ(k))² (5)

where Aᵢ(j) is the ith element of A(j), Bᵢ(k) is the ith element of B(k), and Z is the number of different monomer types in the polymer (e.g., Z=20 for a naturally occurring protein). To analyze the contextual similarity of all N_{A} monomers of protein A with respect to all N_{B} monomers of protein B, an N_{A}×N_{B} difference matrix can be constructed having elements D_{A(j)B(k)} (j=1 to N_{A} and k=1 to N_{B}). By plotting which elements of a difference matrix where D_{A(j)B(k)} have a small magnitude (e.g., less than 10%, 5%, 3%, 2%, or 1% of the maximal difference in the matrix), clusters of monomers having similar context, and thus similar energetic profiles (i.e., energy “colors”), can be identified. If the contextual importance of these regions remains high upon application of F (from the equation FD_{P}=I*D*F) to implement the tendency of amino acid to stabilize the structure by contact in important regions, such regions are predicted to interact with one another. This method can be used to determine, e.g., whether two proteins or protein domains interact with one another. The methods can also be used to determine the locations of the interaction surfaces (see, e.g., Example 3 and FIGS. 8A and 8B). Thus, if protein A is known to interact with several other proteins, it can be readily determined, e.g., by inspecting a graph showing which difference matrix elements that have small magnitudes, whether each of the other proteins interacts with protein A at the same or a different surface (e.g., by looking at where each of the other proteins contacts protein A). Likewise, it can be readily determined, e.g., by inspecting the graph, whether any of the other proteins interact with protein A in a similar manner (e.g., by looking at where protein A contacts each of the other proteins).

Using these methods, PVD difference matrix databases can be constructed and systematically analyzed for predicted protein-protein interactions. Calibration of the method, e.g., in terms of which elements of a difference matrix to graph and how large the area of context similarity needs to be in order to represent an actual protein-protein interaction, can be performed by using the methods to compare proteins sequences which have known interactions. In some embodiments, the PVDs for all the proteins in the PVD database will be calculated using an impulse function having the same width. In other embodiments, the PVDs for each protein in the PVD database will be calculated using an impulse function with an optimized width (e.g., optimized for each sequence).

It will be understood by one skilled in the art that there are numerous methods for analyzing the simiarity/difference between two vectors (e.g., PVDs), any of which may be adapted to the methods of the invention.

The Context Similarity Scheme (E-MAAP™)

Context centers (CCs) identify regions along a polymer chain where a distinct type of monomer (e.g., amino acid) in the polymer dominates the contribution from the regions to the contextual properties of the complete polymer sequence. Such regions have important chemical, physical, and ultimately energetic characteristics, and how they affect and relate to each other influences the properties of the polymer (e.g., the folding and functional characteristics of a protein).

Instructions for how context centers arrange themselves into higher order structures are encoded in the context of the individual monomers that make up polymer sequences. Mapping such information requires the determination of regions in the primary sequence that have the most contextual similarity or dissimilarity as compared to other regions within the polymer (e.g., the entire polymer or limited domains of the polymer). In some embodiments, the energetic properties of individual monomers can be introduced in order to uniquely identify regions with similar context. The process of mapping the contextual information (i.e., generating an E-MAAP™) involves two basic steps:

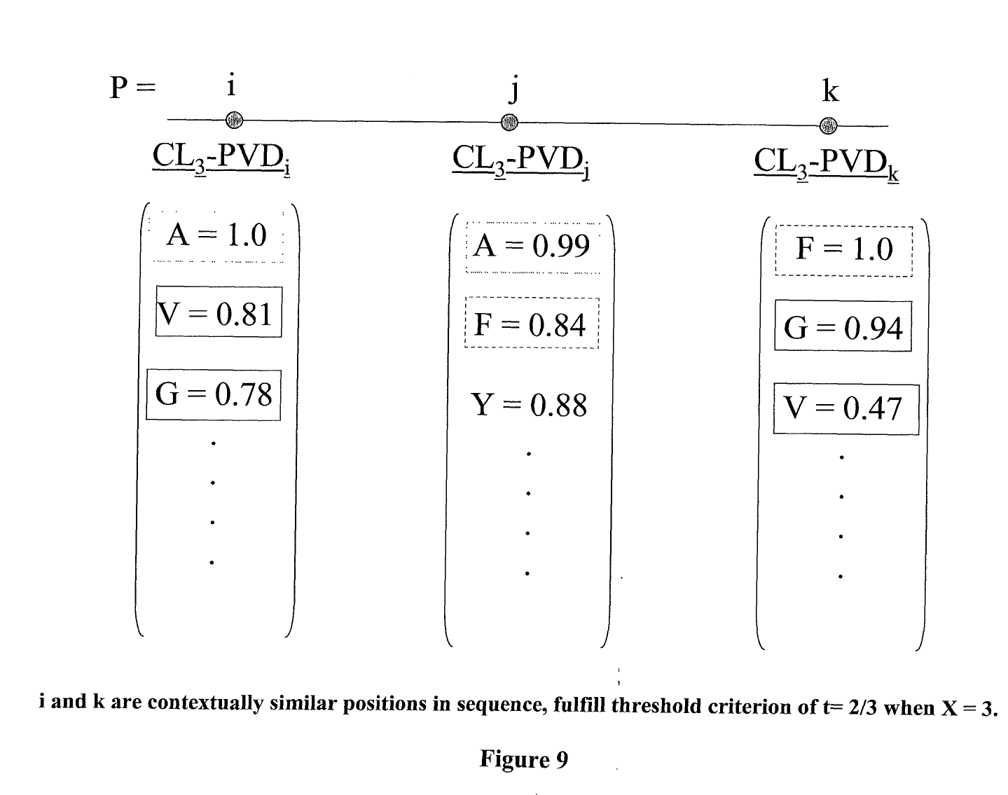

A. The criterion for assessing context similarity between any two positions i and j along an polymer (e.g., protein) chain is first defined. Two parameters are required. The first parameter is the number of CLMs, X, found in CL_{X}PVDᵢ and CL_{X}PVDⱼ, and the second parameter is the threshold number, t, where t is the minimal number of CLMs in both CL_{X}PVDᵢ and CL_{X}PVDⱼ that must be chemically identical in order to define the two PVDs as contextually similar. The assessment of contextual similarity using CL_{X}PVDs and the threshold t is illustrated for a polypeptide sequence in FIG. 9, where three sequence positions, i, j and k, are shown. The parameters X and t are set to 3 and 2, respectively. Given these values for X and t, positions i and j are not contextually similar; only one monomer unit within the criterion parameters is identical in both CL₃PVDᵢ and CL₃PVDⱼ, alanine. Likewise, positions j and k are not contextually similar, since only one monomer, phenylalanine, is common to both CL₃PVDⱼ and CL₃PVDₖ. Positions i and k are contextually similar. Glycine and valine are present in both CL₃PVDᵢ and CL₃PVDₖ. The systematic comparisons of CL_{X}PVDᵢ and CL_{X}PVDⱼ for all monomer positions in a sequence, using a chosen set of X and t parameter values is used to construct an initial E-MAAP™. At this point, no scale is mapped onto the extent of context similarity. Thus the E-MAAP™ is a two-dimensional display, which simply states whether there is context similarity or not between any two positions along an amino acid chain. A “0” can be used to denote dissimilarity and a “1” can be used to denote two positions that share context similarity. In these methods, the parameters X and t can be assigned different values, e.g., (X,t)=(2,1), (3,2), (4,2), (4,3), (5,3), (5,4), etc. In general, t will be 50% of the value of X, or larger. In prefered embodiments, (X,t)=(3,2) or (4,3).

B. As noted above, the magnitudes of the elements of a PVD are linked to the triangular impulse window, W, used to calculate FD_{P} values and to the context of position P created by monomers surrounding this studied sequence position. The E-MAAP™ of step A can be converted into a three-dimensional plot by the combination of context described in similar positions i and j (evaluated for a given set of X and t), for example, by summing the X largest elements of PVD at position i and X largest elements of PVD at position j. This can be done either for a fixed impulse width (preferably the optimal W, as defined above) or for every impulse width in a range, e.g., W=2 to N or any range thereof, e.g., W=2 to N/2. The last variant makes resulting E-MAAP independent of W. The resulting W-independent E-MAAP™ reveals the effect of increasing the global or local properties of the PVDs used to construct the map.

### Identification of Protein Folds Using E-MAAPT™s

By definition, regions with similar context have common and unique physico-chemical properties. These regions also maintain their uniqueness when modifications of their context properties are made. In some embodiments, quantification of these unique properties scales the E-MAAP™ and leads to richer information that more clearly reveals context relationships within the polymer (e.g., protein) chain. Unique context signatures are also obtained. Such context signatures can be used for comparisons with analogous signatures of other amino acid sequences, e.g., for the purpose of structural homology determination. Quantification is accomplished by using the weighted sum of selected physico-chemical properties (e.g., cohesion energies, electron densities, hydrophobicity, electrostatic potentials, free energies, accessible surface areas, statistically determined propensities, etc.) of the CLMs in contextually similar positions. In some embodiments, the methods of quantifying the physical properties of an E-MAAP™ include the following steps:

1. Identify all pairs of contextually similar positions, (i, j), e.g., as described above for the construction of a E-MAAP™ using a fixed set of parameters, e.g., (X,t)=(3,2).

2. Assign a physical, chemical, or biological property to each monomer, depending upon the purpose of analysis. For example, cohesion energies are useful for identifying contextual signatures of protein folds. Cohesion energies for the 20 natural amino acids have been evaluated by K. Timberlake (1998), Chemistry of Life, Addison Wesley, the contents of which are incorporated herein by refernece. Throughout the remainder of this discussion, the term “properties” refers to the cohesion energies unless specifically stated otherwise. In the hypothetical sequence described earlier, i and k were a pair of positions that had context similarity for (X,t)=(3,2). The cohesion energy (or any other property) for the contextually similar pair of monomers can be represented by a weighted sum of the cohesion energy values (εₐₐ) corresponding to the six (i.e., 2X) monomers in the set of CL_{X}PVD elements.

3. The weighted sum, S, for the cohesion energy of a pair of contextually similar monomers i and j is calculated using the following expression:

Sᵢⱼ=Σ_{m=1toX}(ε_{aa,m}*α_{i,m})+Σ_{m=1toX}(ε_{aa,m}*α_{j,m}) (6)

where ε_{aa,m} is the cohesion energy value for the mth monomer in the CL_{X}PVD of residue i or j, α_{i,m} is the magnitude of the mth monomer element in the CL_{X}PVD of residue i, and α_{j,m} is the magnitude of the mth monomer element in the CL_{X}PVD of residue j. Thus, for monomers i and k discussed above (see also FIG. 9),

Sᵢₖ=(εₐₗₐ*1.0+εᵥₐₗ*0.81+ε_{gly}*0.78)+(εₚₕₑ*1.0+ε_{gly}*0.94+εᵥₐₗ*0.47)

4. Each “1” in a two dimensional E-MAAP™ is then replaced by the Sᵢⱼ values calculated for the corresponding contextually similar positions.

5. Steps 1-4 can be repeated for all W, e.g., W=2 to N or some range therein, e.g., W=2 to N/2. The results can be stored in an intermediate database, e.g., consisting of sets of matrices called protein fold context signatures. Each matrix set represents all triangular impulse window sizes, W, for a given threshold, t, and CLM range, X.

6. A Global context signature (GCS), e.g., representing a protein fold when cohesion energies are used to scale the E-MAAP™, is calculated by summing the matrices of step 5:

GCSᵢⱼ=Σ_{W}Sᵢⱼ (7)

where the sum of Sᵢⱼ is taken for each value of W, e.g., W=2 to N/2. Averaging, normalization or any other mathematical transformation can be used to re-scale the GCSᵢⱼ values.

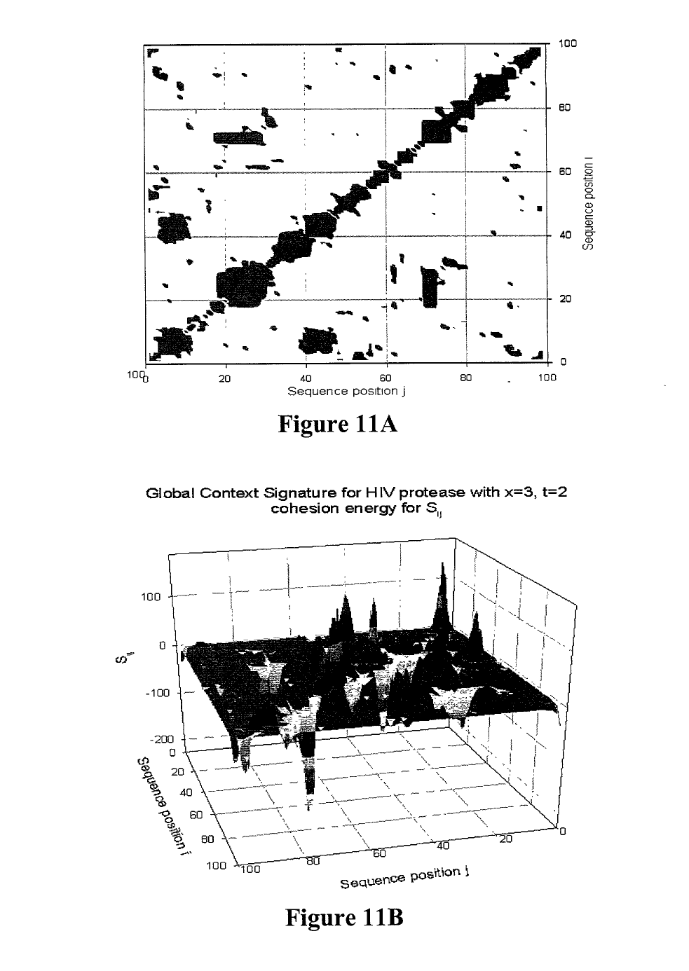

When GSCs are calculated using cohesion energies to scale the underlying E-MAAP™s, distinctly different GCSs will be produced for different protein folds. Thus, proteins with the same or similar three-dimensional fold can be recognized by the similarity of their cohesion energy GCSs, even though the proteins might not exhibit significant homology (as determined by standard primary sequence alignment). GCS surfaces can be compared to one another, e.g., by the sum of the squares of differences for scaled E-maaps, information entropy determination, pattern matxhing algorithms, image analysis, phase correlation algorithms (which has advantages in Fourier space, since the comparison algorithm is independent of map size), etc. An example of the GCS for HIV protease is shown in FIG. 11.

In the above description, the E-MAAP™s are scaled after first being constructed. In some embodiments of the invention, the PVDs can be scaled prior to the construction of the E-MAAP™. For example, each element of a PVD can be multiplied by a physical/chemical parameter of interest (e.g., cohesion energy) prior to being evaluated for contextual similarity. As a result, the CLMs of a PVD can change, thereby impacting the determination of which monomers are contextually similar during the process of building the E-MAAP™. Such manipulation can, in some cases, improve the predictive power of the resulting E-MAAP™. When the PVD is scaled prior to the identification of CLMs, equation (6) above simplifies to:

Sᵢⱼ=Σ_{m=1toX}α_{i,m}+Σ_{m=1toX}α_{j,m} (8)

where α_{i,m} is the magnitude of the mth monomer element in the scaled CL_{X}PVD of residue i, and α_{j,m} is the magnitude of the mth monomer element in the scaled CL_{X}PVD of residue j.

Other Uses for E-MAAP™s

In addition to being used to characterize the fold of a polymer (e.g., a protein), E-MAAP™s can be used to predict the folding nuclei and folding rate constants of a protein, as well as to identify contextually important polymer subsequences such as active site residues.

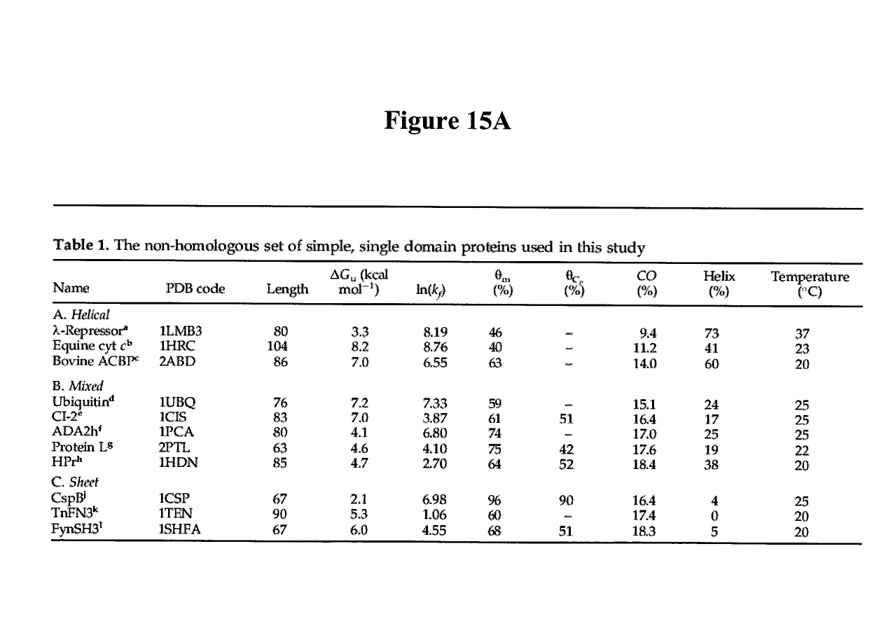

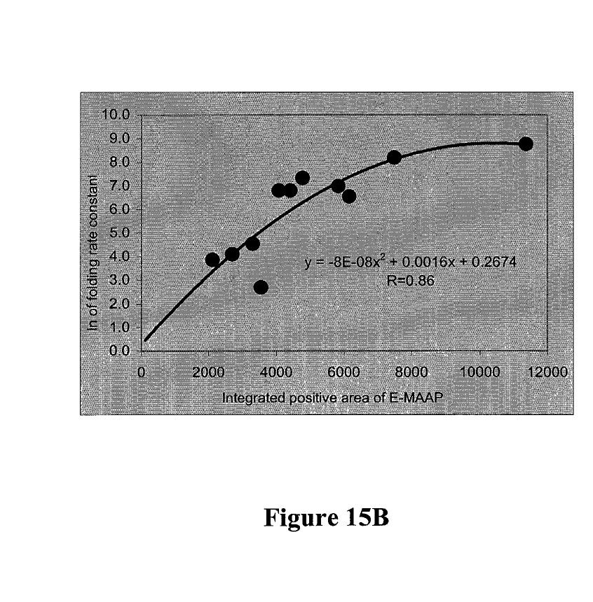

The prediction of folding nuclei and folding rate constants is a modification of the methods for constructing cohesion energy GCSs, described above. Instead of scaling the E-MAAP™s using amino acid cohesion energies, though, the E-MAAP™s are scaled using the Richardson hydrophobicity scale. See, e.g., J. S. Richardson and D. C. Richardson (1988), Science 240:648-1652, the contents of which are incorporated herein by reference. The off-diagonal peaks that have a positive value on a hydrophobicity GCS (i.e., the peaks showing contextual similarity between two positions in a polymer chain that are contextually dominated by hydrophobic amino acids) represent the folding nuclei of the polymer, with the largest peaks being the most critical for the formation of folding nuclei. Furthermore, the integrated volume of the positive region on the hydrophobicity GCS has a correlation of 0.75-0.8 with known folding rate constants for a set of single domain proteins (a benchmark series of biomolecules used to validate theoretical methods of proten folding studies). Thus, using regression analysis on the positive volume of hydrophobicity GCSs and corresponding folding rate constants for proteins having known folding rate constants (and, of course, known primary sequence), it is possible to develop an equation that predicts folding rate constants for proteins that have not been studied with respect to folding. FIG. 15 depicts an analysis of folding rate constants and the volume of the positive area in a hydrophobicity GCS. See also, e.g., Contact Order, Transition State Placement and the Refolding Rates of Single Domain Proteins. Kevin W. Plaxco, Kim T. Simons and David Baker (1998), J. Mol. Biol. 277:985-994.

The identification of contextually important regions in a polymer (e.g., a protein) using E-MAAP™s starts with a dimensionally reduced GCS. While the GCS can be considered a surface, it is also a N×N matrix with values at positions i,j for all i=1 to N and all j=1 to N. The GCS can be dimensionally reduced, e.g., by summing elements within a single row or column that lie within a fixed interval around the central diagonal (i.e., the points defined by i=j, for all i=1 to N and all j=1 to N). For example, consider the position 20,20, and an interval of +/−10. The sum of the elements would be as follows:

2D-GSC₂₀=Σᵢ₌₁₀ₜₒ₃₀GCS_{i,j=20} (9)

The same result is obtained whether the term 2D-GSC20 is summed for the interval i=10 to 30, keeping j=20 constant, or the interval j=10 to 30, keeping i=20 constant. The graph of 2D-GSCₖ, for k=1 to N is called the “Center Profile”. The maximum/minimum value (depending upon whether or not it is scaled, and how it is scaled) of the Center Profile identifies regions of high contextual importance in the polymer, such as the active site. As the center profile is dependent on the GCS and underlying E-MAAP™s, the center profile can be scaled using physical parameters for the amino acids, such as cohesion energies, electron densities, hydrophobicity, electrostatic potentials, free energies, accessible surface areas, statistically determined propensities, etc., of amino acids, as for example propensity to be a part of regular secondary structure segment, or loop connecting these segments, propensity to form regions of inter-domain or protein-protein contacts, etc. As it is known that for most enzymes the active site that binds substrate is formed by one ore more loop regions, the modification of contextual descriptor by the last two propensities is preferred for the applications in which center profile is used to identify the active site. Structural basis is thus: active site is contextually unique, and we combine that novel information with known generalization of observation where the active site is located in known structures. Combination of information from this scaling and another one using the interaction site forming propensities allows the resolution of ambiguities related to the fact that interaction site that guarantees specificity of protein-protein interaction should be also contextually unique and thus will be characterized also by the extremes of central profile.

Heterogeneous E-MAAP™s

The above discussion of “homogeneous” E-MAAP™s and GCSs has been limited to the analysis of a single polymer (i.e., the identification of contextually similar regions within a polymer). E-MAAP™s and GCSs can also be used to identify contextually similar regions in two different polymers, using the (X,t) criteria. Such E-MAAP™s are called “heterogeneous” E-MAAP™s. The methods are identical to those described above. Thus, heterogeneous E-MAAP™s can be scaled with a physical parameter, e.g., cohesion energies, electron densities, hydrophobicity, electrostatic potentials, free energies, accessible surface areas, statistically determined propensities, etc. corresponding to each monomer, after they are constructed, or the PVDs can be scaled with a physical parameter prior to the production of an E-MAAP™. Similarly, “heterogeneous” GCSs can be constructed by summing E-MAAPTMs for a range of impulse widths (W). In some embodiments, scaled, e.g., with amino acid cohesion energies, interface forming propensities, hydrophobicities, or other properties preferably quantifying features relevant for the stabilization energy of the oligomer of protein subunits, heterogeneous E-MAAP™s can be used to identify sites of protein-protein interaction. Thus, heterogeneous E-MAAP™s can be used in ways similar to the PVD difference matrices discussed above.

The Context Functional Surface (CFS)

To emphasize sequence order and content (in addition to monomer frequency) with respect to a particular position in a polymer, a complete representative surface of the three components of context, called the context functional surface (CFS) can be constructed.

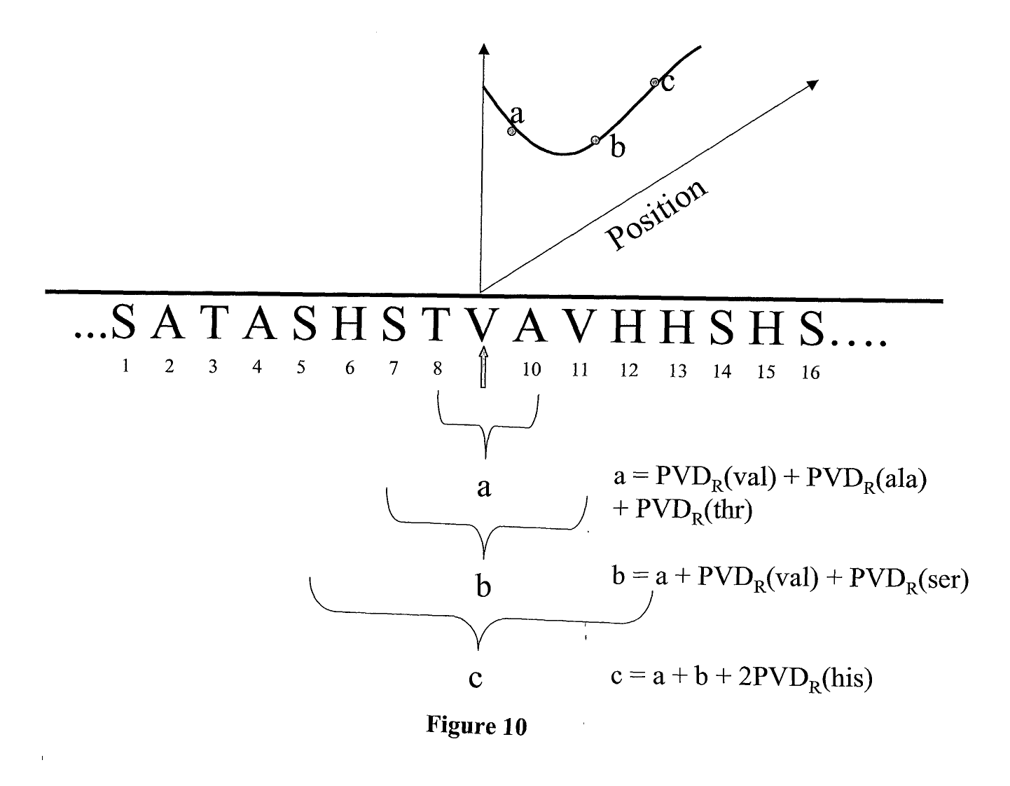

A CFS is constructed for every position, P, in the linear sequence of a polymer, using the elements of a particular PVD (either the PVD for position P or a PVD for any one of the other positions in the polymer). The values of a CFS are plotted with respect to the “context coordinate”, which represents the distance that a monomer is from the monomer at position P. For convenience, the polymer sequence is circularized so that there are a total of (N−1)/2 or N/2 units on the context coordinate. Starting at position P (zero on the context coordinate), the value of the CFS, in particular CFS_{R,P}, is equal to the value of the element in PVD_{R} that corresponds to the monomer at position P. For example, if the polymer is a protein and the monomer at position P is a valine, the value for CFS_{R,P} at zero on the context coordinate is equal to the value of the element representing valine in PVD_{R}. At the next position on the context coordinate, position 1, the value of CFS_{P,R} is equal to the value of CFS_{R,P} at position zero on the context coordinate plus the value of the elements in PVD_{R} corresponding to the monomers that are the nearest neighbors of the monomer at position P in the polymer. This is shown in FIG. 10, where the monomers neighboring the valine at position P are threonine and alanine. Thus, the value of CFS_{R,P} at position 1 on the context coordinate is equal to the value of CFS_{R,P} at position zero on the context coordinate plus the value of the elements in PVD_{R} corresponding to threonine and alanine. The value of CFS_{R,P} at position 2 on the context coordinate is equal to the value of CFS_{R,P} at position 1 on the context coordinate plus the values of the elements in PVD_{R} corresponding to the monomers that are the next-nearest neighbors of the monomer at position P in the polymer, and so on. The process continues until all positions containing monomers in the polymer represented by the values assigned to their chemical identities by a context at position R have been used in construction of CFS_{R,P}. For a given PVD, e.g., PVD_{R}, a CFS can be constructed for every position in a polymer chain, thereby defining, e.g., a three-dimensional surface, CFS_{R}. Since there is a unique PVD for each monomer in a polymer sequence, there can be a total of N unique three-dimensional CFS_{R} surfaces that can be generated for a polymer having N monomers.

A single CFS can be a function of two dimensions, as discussed above, or more depending on the form of the PVD's and the algorithm used to calculate the CFSs. Mathematical methods that can be employed to generate CFSs include cumulative summation (discussed above), clustering or correlation methods, or other methods known in the art. See, e.g., Standard Mathematical Tables & Formulae, 30th edition, D. Zwillinger Ed., CRC Press, New York, 1996, the content of which are incorporated herein by reference.

The results of the CFS generation process are optionally modified and stored in a database. Modifications might include, but are not limited to, average CFS subtraction, linear base line subtraction, normalization, resealing, etc. With respect to the PVDs used to generate the CFSs, elements in each PVD can be normalized by the average of all monomer element values in the PVD, and the normalized PVD can be rescaled, e.g., over the interval from −1 to +1. Furthermore, the width of the impulse function used to calculate the PVDs can be for any W, e.g., W=2 to N. In some embodiments, the impulse function used to calculate the PVDs can have a constant value (i.e., W=∞). Preferably, the impulse function used to calculated the PVDs have an optimized width.

Since there are subsets of residues that contribute to contextually unique and important sub-environments within a polymer chain are created by subsets of monomer residues, elements of the PVD associated with the monomers that characterize this sequentially unique context in the given protein chain will be highly positive. Those elements that represent monomers, which do not contribute to unique context environment of a given sequence position will be more negative. If the amino acid context coding found at position R is applied to all other positions in the sequence, then it follows that if there is another position P (other than R) in which a similar amino acid subset generates context similar to that of position P, the CFS_{R} vector at position P will be characterized by a positive slope. If the context of position P (other than R) is determined by a monomer subset largely different from those contextually important at R, the slope of the CFS_{R} vector at position P will be negative. This link between the PVD and the slope and/or sign of the CFS carries different degrees of importance, depending on the application of the CFS. In some embodiments, only the sign and sign changes that occur along the sequence axis are important. In other applications the actual values of the CFS are required. For example, the sign (and corresponding sign changes) of the CFS are used in analysis of the identity of secondary structures of sequence segments. The values of the CFS are needed to construct and identify active sites of proteins from primary sequences. This latter task requires the construction of the global functional descriptor (GFD) from the CFS, as described below.

Use of the CFS to Determine the Identity of Secondary Structure Segments

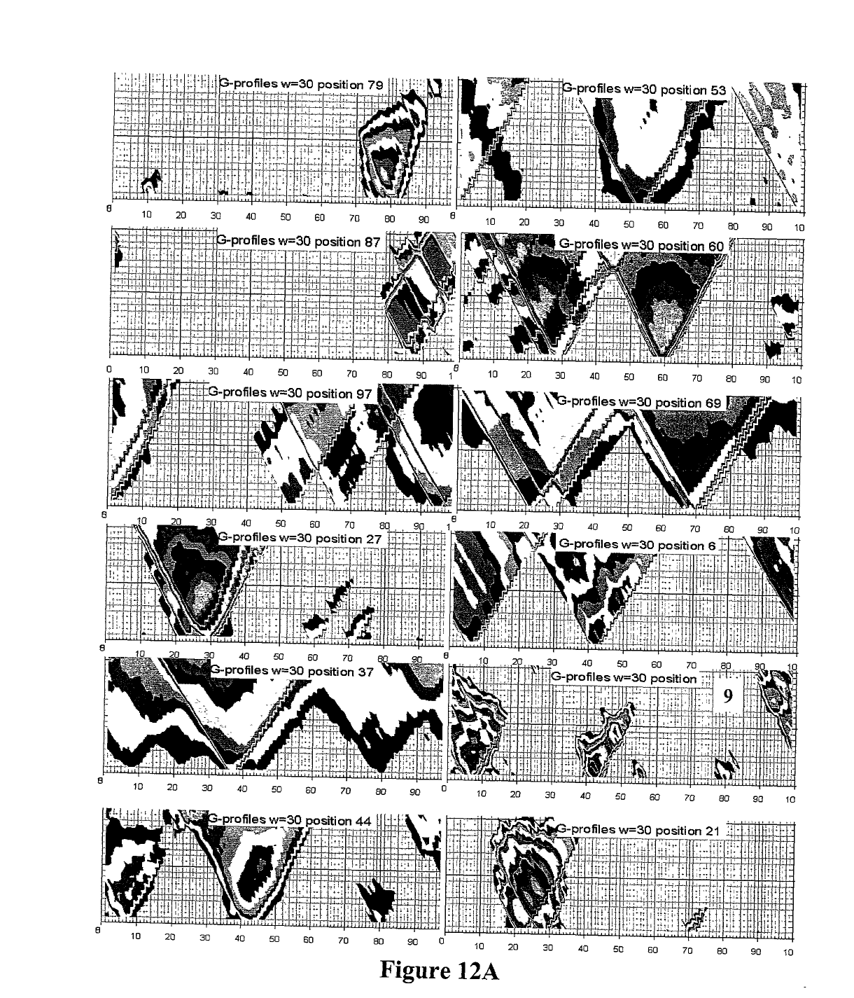

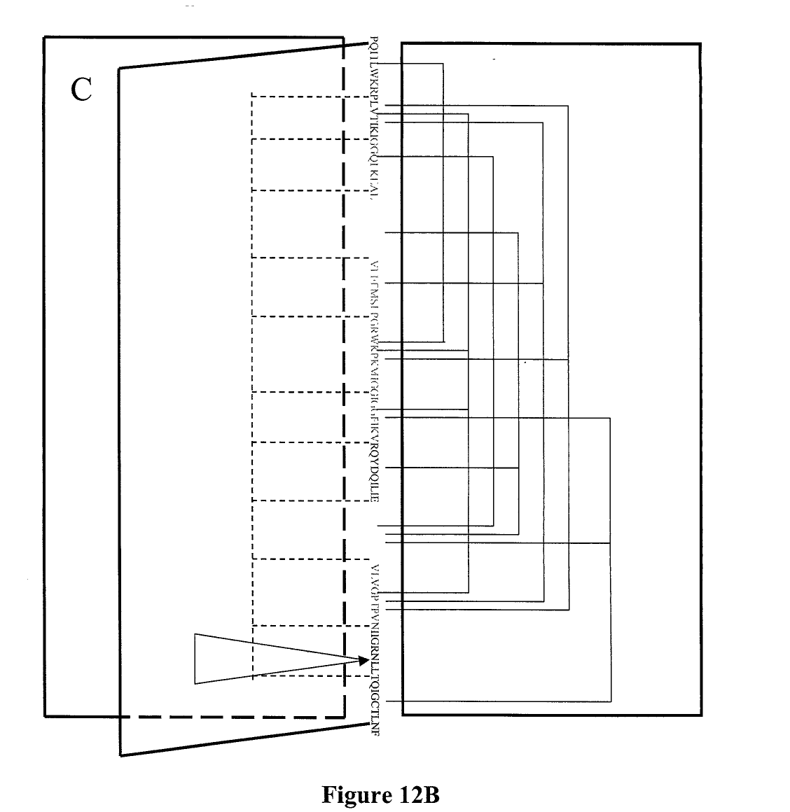

In some embodiments, the CFS can be used to identify related secondary structure segments. For example, using results from the PVD-based determination of secondary structure boundaries, as described above, three-dimensional CFS_{R} surfaces can be calculated with reference to the PVDs of monomers positioned inside each predicted secondary structure segment. Selection of a position at a CC or TCC close to the midpoint of each predicted segment provides optimum results. Plots called “G-profiles”, representing the positive parts of each three-dimension CFS_{R} surface, can be constructed (e.g., see FIG. 12A). Typically, the plots are restricted to a limited set of values on the context coordinate, e.g., Q=1 to 20. Such restrictions are not necessary, but can be preferable. Information related to the identity of secondary structures is localized in the context corresponding to a sequence segment. The context coordinate restriction eliminates biasing of the algorithm by context information in other less local regions of the protein, encoded in CFS values that are farther from the origin.

Next, a book graph (as shown in FIG. 12B), with the spine defined by the sequence being analyzed, is constructed. The book graph can have, e.g., three or more sheets, each corresponding to a secondary structure designation, e.g., α-helical, β-strand, and “other” (e.g., loop). The identified secondary structure segments of the polymer sequence represent the vertices of the book graph. If the G-profile for a given CFS_{R} is positive and points to any position P, where P does not equal R, the vertices in the book graph corresponding to these two segments are connected with an “edge” that becomes associated with an arbitrarily chosen page of the book graph. The procedure is repeated for every CFS_{R} corresponding to a position R located in each predicted secondary structure segement, e.g., at a CC or TCC close to the midpoint of each predicted segment. If one of the vertices that becomes connected by an edge is already associated with a particular page in the book graph, the new edge also becomes associated with that page. The boundaries between the secondary structure segments are automatically associated with a common page of the book graph and assigned “other” or “loop” secondary structure identity. The other pages can represent α-helical and β-strand secondary structures. In some embodiments, there is more than one page in the book corresponding to α-helical or β-strand secondary structures, e.g., indicating the existence of different classes of such structures. In some embodiments, the edges connecting two predicted secondary structure elements are only added to the book if the G-profiles for each position R1 and R2 reciprically indicate contextual similarity of the one position (e.g., R1) with the predicted secondary structure segment in which the other position (e.g., R2) is located. The particular type of secondary structure (e.g., α-helical or β-strand) associated with a page in the book may, in some embodiments, be predicted using consensus secondary structure predicting methods known in the art, experimental data on the protein of interest (e.g., spectroscopy and/or folding energies), or by a method using context-based descriptors.

The Global Context Descriptor (GCD)

A global context descriptor (GCD) can be constructed for every linear polymer sequence using CFSs. The concept of similarity is used to compress the extensive context information at positions in the sequence, which is encoded in the CFS, into a manageable, but highly structurally significant global descriptor. The inputs are all CFS_{R,P} database entries for the particular polymer sequence being considered. For each position P in the primary sequence, the corresponding component of a CFS_{R} at that position is processed by a dimensionality reduction algorithm. Such algorithms are common in the art and include principal component reduction, eigenvalue representation, self-organizing map methods of artificial intelligence, neural network methods, convolution integration, matrix multiplication, variance analysis methods, etc. See, e.g., Artificial Intelligence: A Modern Approach, Russel, S., Norvig, P., Prentice Hall Series In Artificial Intelligence, 2001, the contents of which are incorporated herein by reference. The result is a reduced context functional surface (RCFS_{R}) for each position R in the polymer sequence. The RCFS_{R}'s can be stored in a database, preferably in a normalized form. The RCFS_{R}'s for all positions, R=1 to N, are combined into a single global context functional surface, GCFS (or global context descriptor, GCD), for the sequence. If the dimensionality reduction step is not performed, CFS_{R}'s for all positions, R=1 to N, can be directly combined into a single GCD. Methods to accomplish this are known in the art and include, for example, direct matrix product, matrix multiplication, and other methods. See, e.g., Standard Mathematical Tables & Formulae, 30th edition, D. Zwillinger Ed., CRC Press New York, 1996.

In molecular terms, the dimensionality reducing algorithm is based on the assumption that the structurally and functionally most important regions of proteins must be recognizable by all other parts of the protein sequence (compare, for example, the evolutionarily conserved regions of enzymes). In terms of the context concept, these regions must have unique contexts, recognizable as such independently of the position from which the context features are evaluated. The shape of the function (e.g., vector) CFS_{R,P} describes the context of position P most completely. It should be reiterated that the function (e.g., vector) of CFS_{R,P} is calculated using elements of PVD_{R} as the characteristic values for the monomers (e.g., amino acids or bases) at all other remaining positions of the sequence. Similarity of the shapes of CFS_{R,P1} and CFS_{R,P2} is found only when the monomer units surrounding positions P1 and P2 form similar contexts. To quantify the extent of contextual similarity for any pair of sequence positions P1 and P2 with respect to position R, the correlation coefficient r_{R,P1P2} of CFS_{R,P1} and CFS_{R,P2} can be calculated, e.g., by integrating their product along the context coordinate (Q):

r_{R,P1P2}=∫CFS_{R,P1}*CFS_{R,P2}dQ (10)

For any position R in a polymer of N monomers, an N×N correlation matrix r_{R} can be calculated and stored in an intermediate database. Elements r_{RP1P2} of this matrix describe quantitatively the similarity of positions P1 and P2, when the sequence context of position R is used at positions P1 and P2. Thus, there is a matrix r_{R} for each position R in the polymer and N r_{R} matices corresponding to a single polymer.

To compress the similarity information encoded in the array of CFS-based correlation matrices r_{R}, an N×N matrix of the GCD having elements gᵢⱼ (i=1 to N, j=1 to N) can be calculated as follows:

A. Select a position R in a polymer sequence (e.g., R=1). Retrieve matrix r_{R} for this position. Next, retrieve matrix r_{R+1} for the neighboring position. Calculate the direct product of the two matrices (an element of the direct product dpᵢⱼ=[r_{R}]ᵢⱼ*[r_{R+1}]ᵢⱼ). If the element dpᵢⱼ of the direct product is larger than a pre-selected threshold value (e.g., 0.95), the value of dpᵢⱼ is added to the value of the element gᵢⱼ of the GCD.

B. Move to the next position R+2, retrieve correlation matrix r_{R+2}, calculate the direct product of r_{R} ans r_{R+2}, and modify the elements of GCD as described above.

C. Repeat step (B) until correlation matrices for all positions following position R have been sampled.

D. Move to position R+1 and repeat steps (A) through (D) until R=N.

The resulting N−N matrix is the GCD, and it is stored in what is called an “Expressway Database”. The GCD serves as a tool for the identification of unique context regions of protein sequences such as those that comprise the active sites of enzymes.

Use of GCDs to Identify Monomers that Contribute to the Active Site

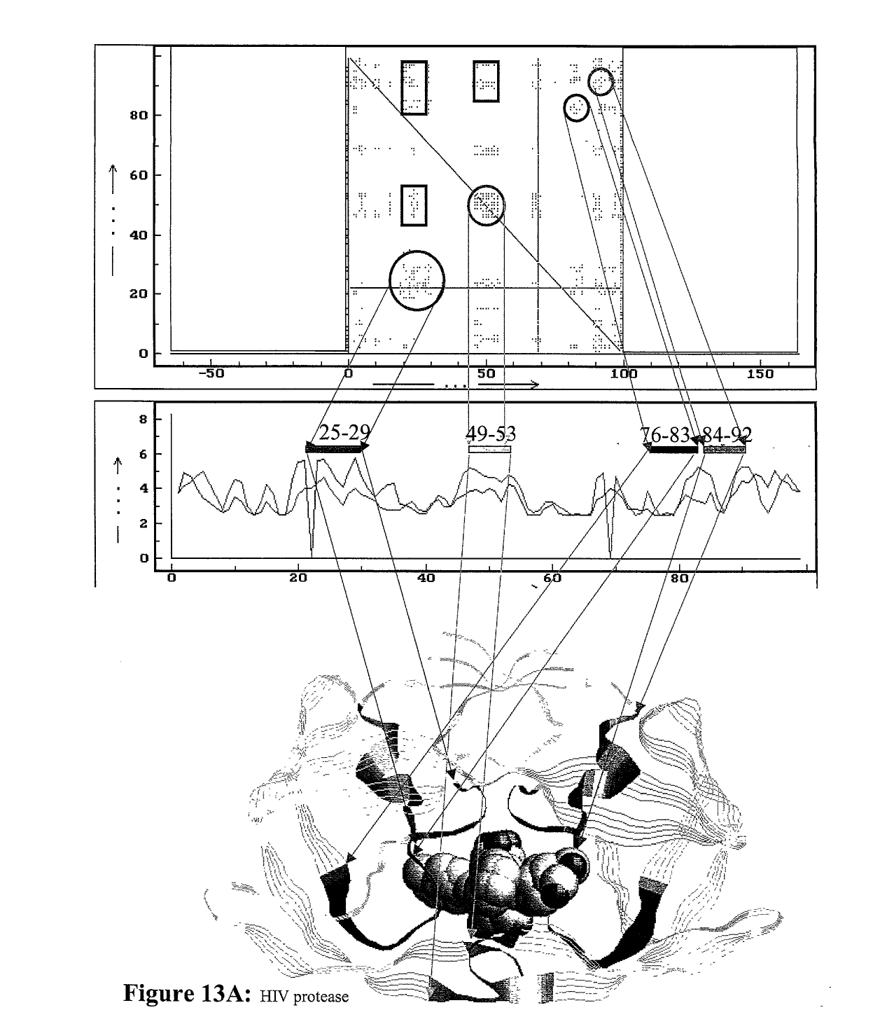

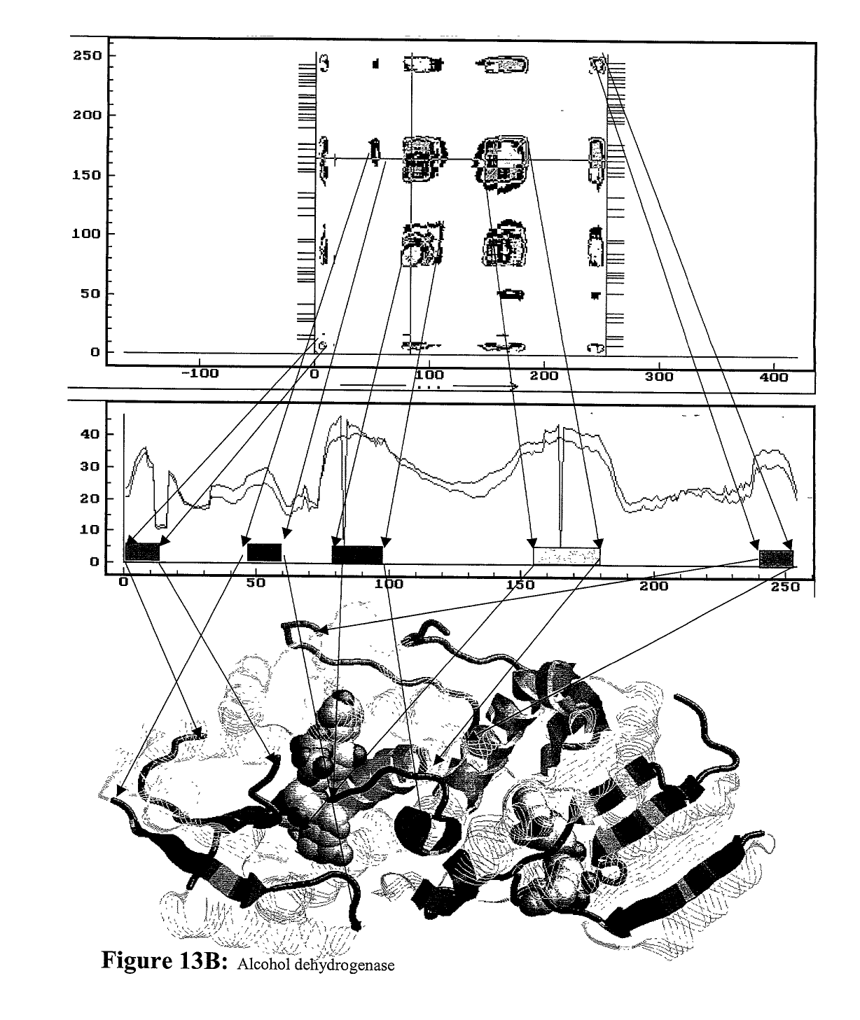

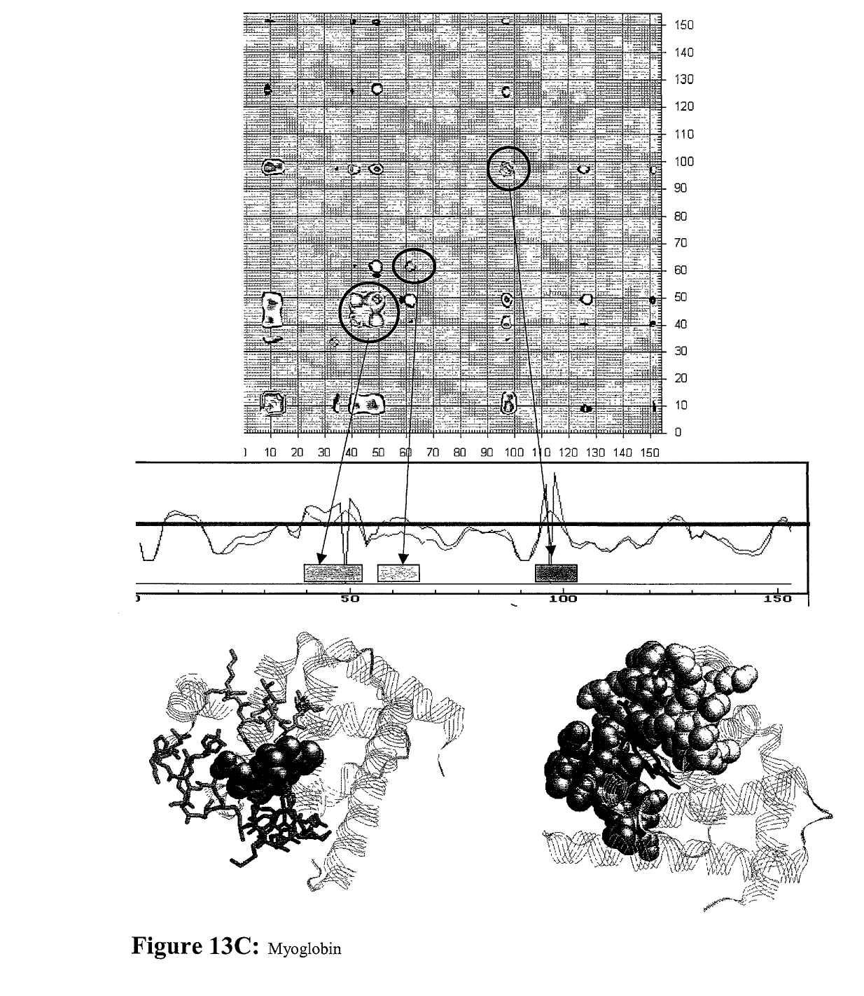

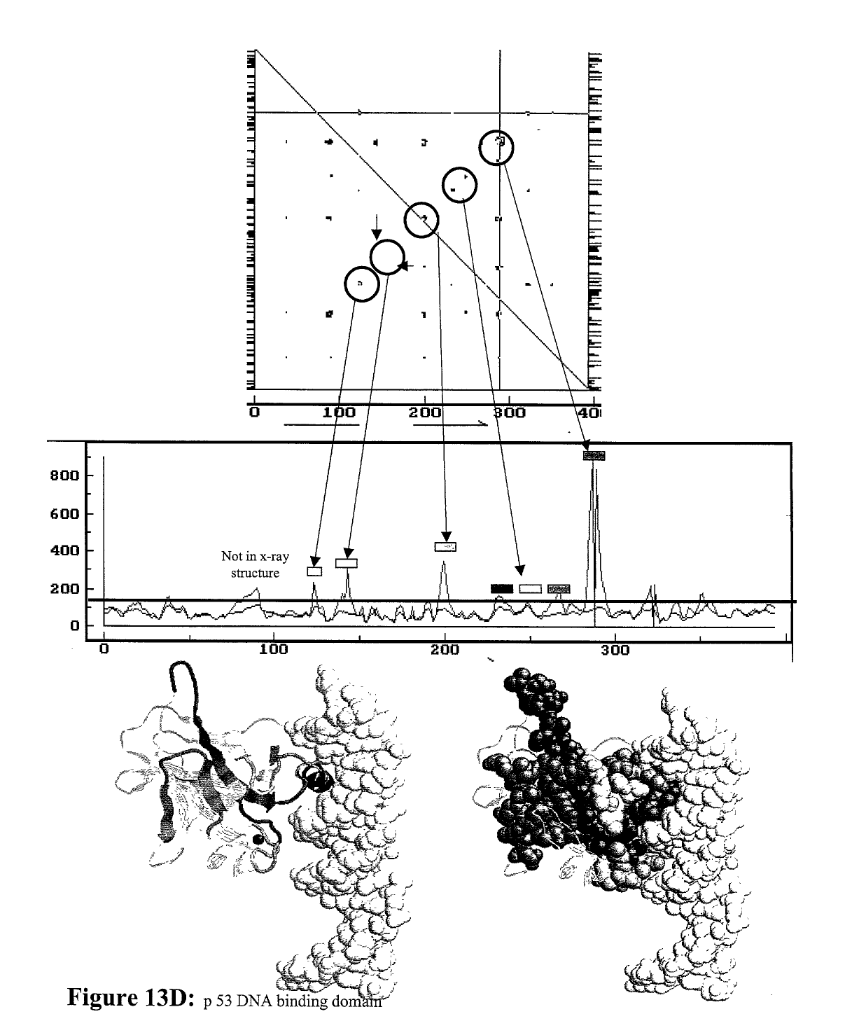

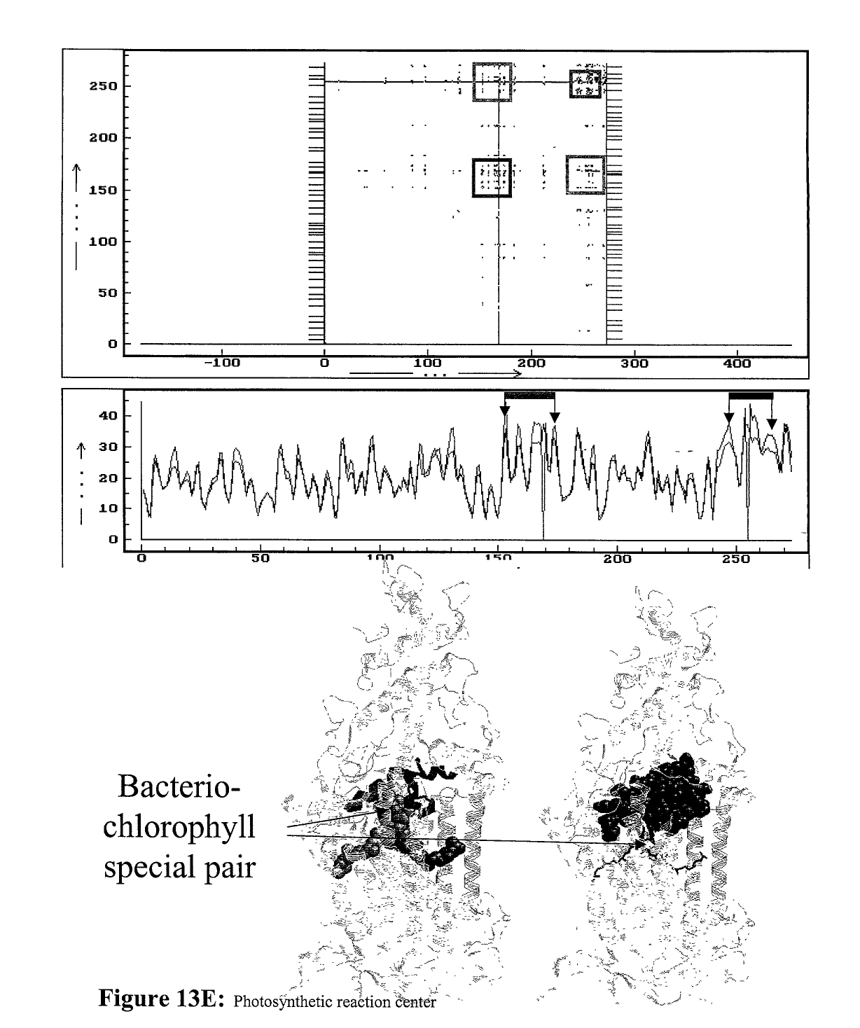

In some embodiments, GCDs can be used to identify contextually unique regions of a polymer (e.g., a protein), which can reflect their role in the formation of the polymer's active site. For a given polymer sequence, a GCD can be calculated for an optimally selected width (W) of the probing impulse (used during the construction of the PVDs). In some embodiments, the elements of the GCD matrix are normalized. The normalized GCD can be represented as a two-dimensional plot, e.g., identifying those elements having positive values larger than an optimal threshold value. The optimal threshold can be 0.5, 0.6, 0.7, preferably 0.75, or higher. Finally, using a suitable algorithm, correlated islands in the two dimensional GCD rendering can be identified. The correlated islands correspond to sequence segments in the polymer that are contextually most unique and recognizable, irrespective of the reference position in the sequence. These contextually unique and correlated segments are often part of, or located in close proximity to, the active sites of a polymer, as shown in FIGS. 13A-E. In some embodiments, the GCD-based predictions can be combined with predictions of secondary structure boundaries (e.g., as described herein), thereby allowing the prediction of whether particular segments of the active site are composed of regular secondary structure segments (e.g., α-helix or β-sheet) or loops of a super-secondary structural motif (e.g., a turn in the helix-turn-helix super-secondary structure). Use of GCDs to Determine the Effect of Mutations on

Protein Function and Activity

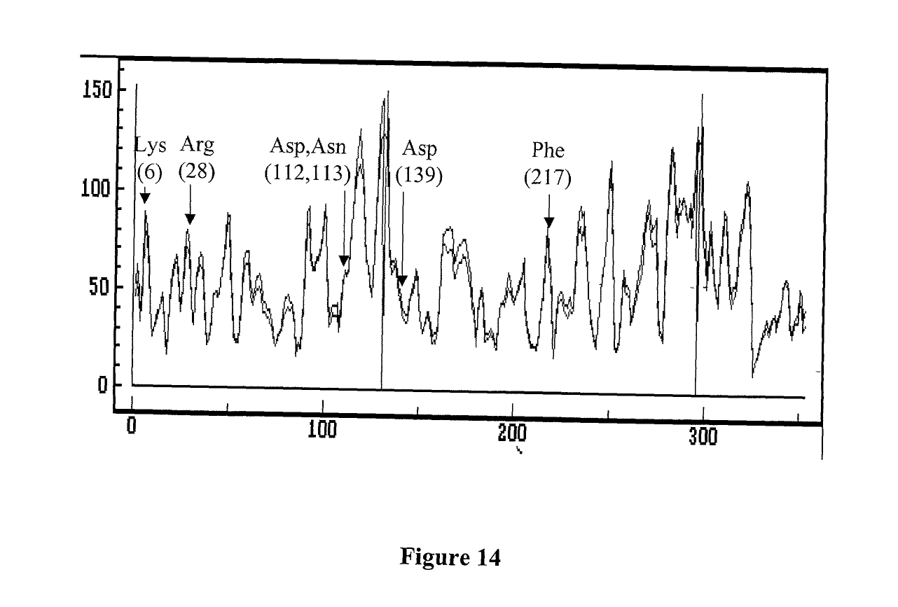

In other embodiments, GCDs can be used to predict the stabilizing or destabilizing effects of introducing alterations in the sequence of a polymer. For example, GCDs can be used to predict whether particular mutations in a protein will be more or less detrimental to the protein's structure and/or function. The methods include first predicting the secondary structure boundaries of a protein, e.g., as described herein. Preferably, the optimal probing width for the impulse function is used when calculating the secondary structure boundaries of the polymer. Based on the secondary structure boundary prediction, the average length Nₐᵥ of the predicted secondary structure segments can be determined. Using an optimal probing width of Nₐᵥ/2 (or less) for the impulse function, PVDs, CLSs, and a GCD can be constructed for the polymer sequence. From the GCD, the position P having a maximal value can be identified. Within the row vector at position P in the GCD, the position R having a second maximal value can be identified. The positions GCD_{P,R} and GCD_{R,P} of the GCD are part of regions having large off-diagonal values. A plot of the row vector of the GFD at position P and the column vector of the GFD at position R (or vise versa) will identify positions in a polymer that have a large or small effect on polymer structure/function, as shown in FIG. 14. For example, peaks in the plot correspond to residue positions that have a detrimental effect on polymer structure/function when altered (e.g., mutated), while valleys in the plot correspond to residue positions that have a relatively small effect (if any) on polymer structure/function when altered. In some embodiments, the mutation propensity at position P can be calculated from the plot by using the largest GFD value at position P (or an average of the two values of the two GFD vectors at position P) together with the PVD elements associated with position P. To do so, one can use standard methods of multiple regression analysis, e.g., least-squares-based optimization of multiparameter regression function, with one independent variable being intensity of GCD and the other PVD, or difference between elements of PVD corresponding to the wild-type and altered sequences, respectively.

Use of GCDs to Locate and Predict Single Nucleotide Polymorphisms

Three basic questions surround the issue of single nucleotide polymorphisms (SNPs) in diagnostic and drug discovery initiatives. If a known SNP exists, can the SNP be accurately diagnosed in a standard repeatable way? Given any gene, what is the likelihood that a SNP exists or will occur? If a SNP does exist, where is the most likely place that a SNP will occur, and at what expected frequency will a SNP occur? Currently, answers to these questions are limited by the available knowledge base of known SNPs for known genes. Errors abound due to things as simple as erroneous submissions of sequence data to sequence data banks, and to the fact that SNPs in gene products are not even discovered if one only has an EST (or cDNA) for that gene.

In some embodiments, GCDs can be used to predict the most likely locations for biologically important single nucleotide polymorphisms (SNPs) in a gene. The following steps can be used in this aspect of the invention:

A. The PVDs are used to obtain CLSs and, eventually, a GCD. As described above, the GCD profile can be used to locate or map regions along the amino acid sequence having a high or low propensity for mutation (e.g., those positions being detrimental to protein function, and vice versa). At the level of nucleic acid sequence (e.g., genomic sequence), regions that have a high propensity to mutate with detrimental outcome manifest themselves as functionally important SNPs.

C. The profile derived from GCD that characterize quantitatively the structural impact of amino acid mutation is converted and scaled to the corresponding nucleic acid sequence, thereby identifying which nucleotides encode amino acid residues having a high or low mutation significance.

D. The location and quantified significance of mutations that alter protein sequence can be scaled for the three bases encoding each amino acid residue. Mutations can occur via substitution, which may result in a conservative (same) or novel (different) amino acid being specified by the codon. Thus, protein mutations may result for changes in ⅓ (one) of the bases in a codon triplet, ⅔ (two) of the bases in a codon triplet, or 3/3 (all three) of the bases in a codon triplet. This factor will alter the likelihood of observing a SNP at a particular location in the nucleic acid sequence.

The results of the SNP identification methods can find therapeutic uses, e.g., for identifying SNPs in highly mutagenic proteins, e.g., viral proteins, as described in Example 8.

Databases

In some aspects, the present invention provides databases (e.g., compilations of computer readable information) containing information relating to the structural and functional characteristics of natural and synthetic polymers. In preferred embodiments, the databases contain information such as PVD vectors, CLSs, and GCDs that describe, in differing ways, the context of monomers present in a polymer sequence (e.g., proteins, nucleic acid sequences, etc.).

Combining the Methods of the Invention

For many applications, the maximum amount of information is obtained when a combination of several of the above-mentioned descriptors are employed. Use of such combinations for different applications is demonstrated in the examples, which address specific structural questions.

Consider first the situation of a homo-molecular sequence, i.e. base pairs of genes or amino acids of proteins, etc. In this case, analysis of the CFSs or GCD identifies sub-sequences of the parent sequence that have similar contexts. Further analysis identifies monomer positions in those sub-sequences having sequence contexts that are unique and distinct from the majority of contexts at other monomer positions in other sub-sequences. In proteins, such regions correspond to secondary structure segments, locations of active sites of enzymatic catalysis, evolutionary conserved regions, and other structurally or functionally important regions. In DNA, such regions correspond to mutation hot-spots, genes, introns and regulatory coding regions.

One type of analysis of hetero-molecular sequences involves consideration of two or more sequences composed of the same type of monomer units. This analysis is applicable, for example, to investigations of protein/protein or DNA/DNA interactions. Either the CFSs or GCD determined for individual sequences, or generated for a sequence concatenation of a pair of sequences into one longer sequence, can be used to identify sequence regions where subunit interactions occur. As an example, the self-association behavior of RecA protein, an example of hetero-molecular interactions, can be analyzed by methods of the present invention. Another example of this application of present invention is p53-BCL-XL association that is important for cell apoptosis. In this case, conclusions about the complex structure that were obtained by hetero-molecular Expressway analysis were experimentally validated by loss of biological activity initiated by the complex of the two proteins for deletion mutants with deletions being engineered in the segments of p53 structure that formed predicted interaction surface.

Analysis of hetero-molecular sequences also involves the consideration of two or more sequences composed of different types of monomer units. For example this analysis is applicable to investigations of protein/DNA interactions. In this case, the CFS and GCD are determined for the individual sequences comprising the pair of sequence entities, and compared. Generality of the formulation allows comparisons of very different molecular entities such as DNA and protein sequences. In the case of DNA/protein interactions the energetics of the participants involved in recognition interactions required for regulation in vivo are considered.

To this point, the generation of context informational databases has been described. Sequences are represented mathematically by context functional descriptors and sequence dependent attributes are related to mathematical properties of the sequences, which capture the integrated interrelations of the attributes (content, identity, order) of context in a novel and highly useful way. As will be seen in the examples, consideration of the behaviors of these descriptors reveals important structural and functional information.

### EXAMPLES

### Example 1

### PVD Construction for HIV Protease

The PVD emphasizes context properties of frequency and composition. The third property, order or arrangement of monomers, is encoded within the ensemble of PVD's calculated for all positions of a given sequence. Sequence order is inherent in the way each PVD is constructed from the applied impulse function. That is, the PVD at a particular position is calculated from the response of the surrounding primary sequence to a probing pulse applied at that position. If desired, distance dependent contributions and assigned functional properties of chemical, physical or biological characteristics of each monomer unit at every P in the entire sequence can be implemented. By the nature of the impulse function, those monomer units closest to P are usually, but not necessarily, the elements with the largest values of the PVD at P.

Tables 2 and 3 show a few PVD vectors for HIV protease. The value of each PVD element was determined by summing the probed responses at P for each of the amino acids in the entire chain, as described above and in FIGS. 2 and 3. The method of calculating the responses involved applying the expression FD_{P}=I*D*F, where I was the value that the particular residue has along the triangular impulse function (W=20) centered on the PVD residue (P), D=1/d was a function of the distance away from the PVD residue (P), and F=1. In the construction process, the total summation of each element stoped when all 20 amino acid values in a particular PVD had at least one computed FD_{P} value and/or a particular amino acid was not present in the chain. The first row of each section of Table 2 contains the position index (1 to 6) and the one-letter code of the amino acid residue in the HIV protease sequence (that is, the primary sequence). The second row of each section of Table 2 contains the mean value of the results of the PVD determination before normalization of the PVD elements. The next 20 rows of each section of Table 2 contain the normalized and rescaled (from −1 to +1) elements of the PVD with the chemical identity of each row element shown by the three-letter symbol of the respective amino acid residue. The order of rows is the same for the PVD's of all sequence positions.

TABLE 2

| Sequence position | 1 P | | 2 Q | | 3 I | | 4 T | | 5 L | | 6 W | |
|---|---|---|---|---|---|---|---|---|---|---|---|---|
| PVD average | 0.1480 | | 0.1252 | | 0.1198 | | 0.1220 | | 0.1363 | | 0.1399 | |
| | Ala | −0.1090 | Ala | −0.0857 | Ala | −0.0728 | Ala | −0.0709 | Ala | −0.0815 | Ala | −0.0812 |
| | Cys | 0.0383 | Cys | 0.0313 | Cys | 0.0149 | Cys | −0.0038 | Cys | −0.0310 | Cys | −0.0450 |
| | Asp | −0.1150 | Asp | −0.0915 | Asp | −0.0856 | Asp | −0.0872 | Asp | −0.1009 | Asp | −0.0962 |
| | Glu | −0.1152 | Glu | −0.0833 | Glu | −0.0729 | Glu | −0.0709 | Glu | −0.0811 | Glu | −0.0804 |
| | Phe | 0.8520 | Phe | 0.3748 | Phe | 0.2135 | Phe | 0.1280 | Phe | 0.0637 | Phe | 0.0268 |
| | Gly | −0.0591 | Gly | −0.0407 | Gly | −0.0377 | Gly | −0.0417 | Gly | −0.0561 | Gly | −0.0595 |
| | His | −0.1158 | His | −0.0939 | His | −0.0895 | His | −0.0926 | His | −0.1078 | His | −0.1121 |
| | Ile | −0.0329 | Ile | −0.0038 | Ile | 0.0062 | Ile | 0.0058 | Ile | −0.0092 | Ile | −0.0114 |
| | Lys | −0.0382 | Lys | −0.0114 | Lys | 0.0001 | Lys | 0.0102 | Lys | 0.0117 | Lys | 0.0291 |
| | Leu | −0.0119 | Leu | 0.0089 | Leu | 0.0154 | Leu | 0.0145 | Leu | −0.0032 | Leu | −0.0097 |
| | Met | −0.1194 | Met | −0.0957 | Met | −0.0935 | Met | −0.0950 | Met | −0.1085 | Met | −0.1113 |
| | Asn | 0.0084 | Asn | 0.0188 | Asn | 0.0155 | Asn | 0.0083 | Asn | −0.0176 | Asn | −0.0301 |
| | Pro | 0.0749 | Pro | 0.1189 | Pro | 0.1076 | Pro | 0.0964 | Pro | 0.0793 | Pro | 0.0785 |
| | Gln | 0.0463 | Gln | 0.0572 | Gln | 0.0479 | Gln | 0.0231 | Gln | −0.0063 | Gln | −0.0202 |
| | Arg | −0.0419 | Arg | −0.0106 | Arg | 0.0076 | Arg | 0.0257 | Arg | 0.0455 | Arg | 0.1080 |
| | Ser | −0.1202 | Ser | −0.0966 | Ser | −0.0904 | Ser | −0.0917 | Ser | −0.1051 | Ser | −0.1076 |
| | Thr | 0.0132 | Thr | 0.0370 | Thr | 0.0473 | Thr | 0.0440 | Thr | 0.0264 | Thr | 0.0137 |
| | Val | −0.0655 | Val | −0.0321 | Val | −0.0096 | Val | 0.0017 | Val | 0.0047 | Val | 0.0241 |
| | Trp | 0.0347 | Trp | 0.0999 | Trp | 0.1728 | Trp | 0.2955 | Trp | 0.5911 | Trp | 0.6028 |
| | Tyr | −0.1236 | Tyr | −0.1013 | Tyr | −0.0966 | Tyr | −0.0993 | Tyr | −0.1141 | Tyr | −0.1181 |

Table 3 shows the PVD vectors after the normalized and rescaled PVD elements (and the corresponding amino acid identity for each of them) were re-ordered in descending fashion. The amino acid residue in the HIV protease sequence with the highest positive PVD element at each position (the first row in each PVD column) represents the leading monomer at that position. The chemical identity of the leading monomer at each position is used as the y-coordinate in the LMDM construction. If the chemical identity of the amino acid residue in this first row of the ordered PVD elements is identical to the chemical identity of the amino acid residue in the same position of the protein primary sequence (the first row of the Table), then there is a TCC at that position.

TABLE 3

| Sequence position | 1 P | | 2 Q | | 3 I | | 4 T | | 5 L | | 6 W | |
|---|---|---|---|---|---|---|---|---|---|---|---|---|
| PVD average | 0.1480 | | 0.1252 | | 0.1198 | | 0.1220 | | 0.1363 | | 0.1399 | |
| | Phe | 0.8520 | Phe | 0.3748 | Phe | 0.2135 | Trp | 0.2955 | Trp | 0.5911 | Trp | 0.6028 |
| | Pro | 0.0749 | Pro | 0.1189 | Trp | 0.1728 | Phe | 0.1280 | Pro | 0.0793 | Arg | 0.1080 |
| | Gln | 0.0463 | Trp | 0.0999 | Pro | 0.1076 | Pro | 0.0964 | Phe | 0.0637 | Pro | 0.0785 |
| | Cys | 0.0383 | Gln | 0.0572 | Gln | 0.0479 | Thr | 0.0440 | Arg | 0.0455 | Lys | 0.0291 |
| | Trp | 0.0347 | Thr | 0.0370 | Thr | 0.0473 | Arg | 0.0257 | Thr | 0.0264 | Phe | 0.0268 |
| | Thr | 0.0132 | Cys | 0.0313 | Asn | 0.0155 | Gln | 0.0231 | Lys | 0.0117 | Val | 0.0241 |
| | Asn | 0.0084 | Asn | 0.0188 | Leu | 0.0154 | Leu | 0.0145 | Val | 0.0047 | Thr | 0.0137 |
| | Leu | −0.0119 | Leu | 0.0089 | Cys | 0.0149 | Lys | 0.0102 | Leu | −0.0032 | Leu | −0.0097 |
| | Ile | −0.0329 | Ile | −0.0038 | Arg | 0.0076 | Asn | 0.0083 | Gln | −0.0063 | Ile | −0.0114 |
| | Lys | −0.0382 | Arg | −0.0106 | Ile | 0.0062 | Ile | 0.0058 | Ile | −0.0092 | Gln | −0.0202 |
| | Arg | −0.0419 | Lys | −0.0114 | Lys | 0.0001 | Val | 0.0017 | Asn | −0.0176 | Asn | −0.0301 |
| | Gly | −0.0591 | Val | −0.0321 | Val | −0.0096 | Cys | −0.0038 | Cys | −0.0310 | Cys | −0.0450 |
| | Val | −0.0655 | Gly | −0.0407 | Gly | −0.0377 | Gly | −0.0417 | Gly | −0.0561 | Gly | −0.0595 |
| | Ala | −0.1090 | Glu | −0.0833 | Ala | −0.0728 | Glu | −0.0709 | Glu | −0.0811 | Glu | −0.0804 |
| | Asp | −0.1150 | Ala | −0.0857 | Glu | −0.0729 | Ala | −0.0709 | Ala | −0.0815 | Ala | −0.0812 |
| | Glu | −0.1152 | Asp | −0.0915 | Asp | −0.0856 | Asp | −0.0872 | Asp | −0.1009 | Asp | −0.0962 |
| | His | −0.1158 | His | −0.0939 | His | −0.0895 | Ser | −0.0917 | Ser | −0.1051 | Ser | −0.1076 |
| | Met | −0.1194 | Met | −0.0957 | Ser | −0.0904 | His | −0.0926 | His | −0.1078 | Met | −0.1113 |
| | Ser | −0.1202 | Ser | −0.0966 | Met | −0.0935 | Met | −0.0950 | Met | −0.1085 | His | −0.1121 |
| | Tyr | −0.1236 | Tyr | −0.1013 | Tyr | −0.0966 | Tyr | −0.0993 | Tyr | −0.1141 | Tyr | −0.1181 |

### Example 2

### Determination of Secondary Structural Boundaries in a Folded Protein from the Primary Structure

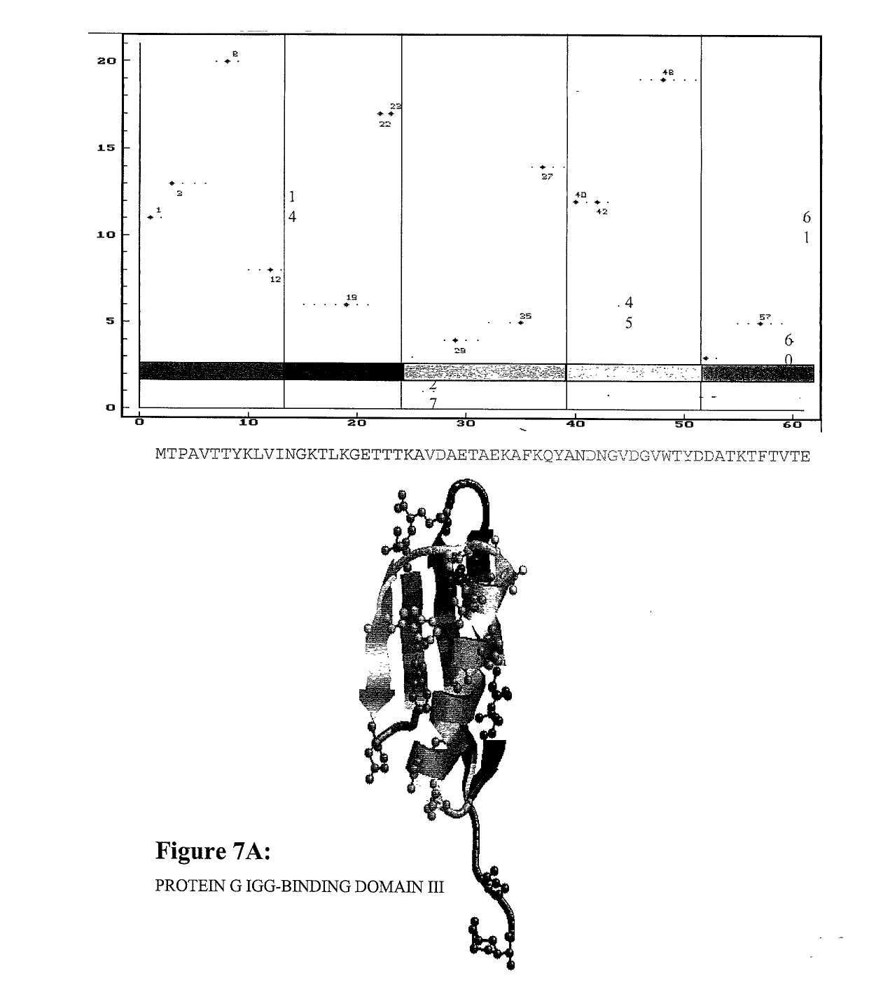

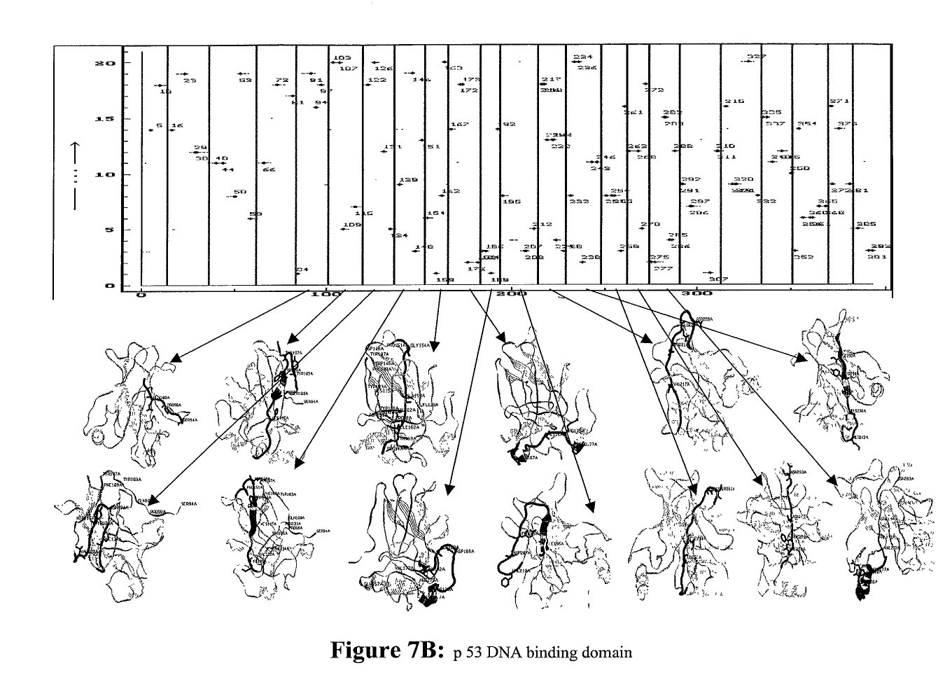

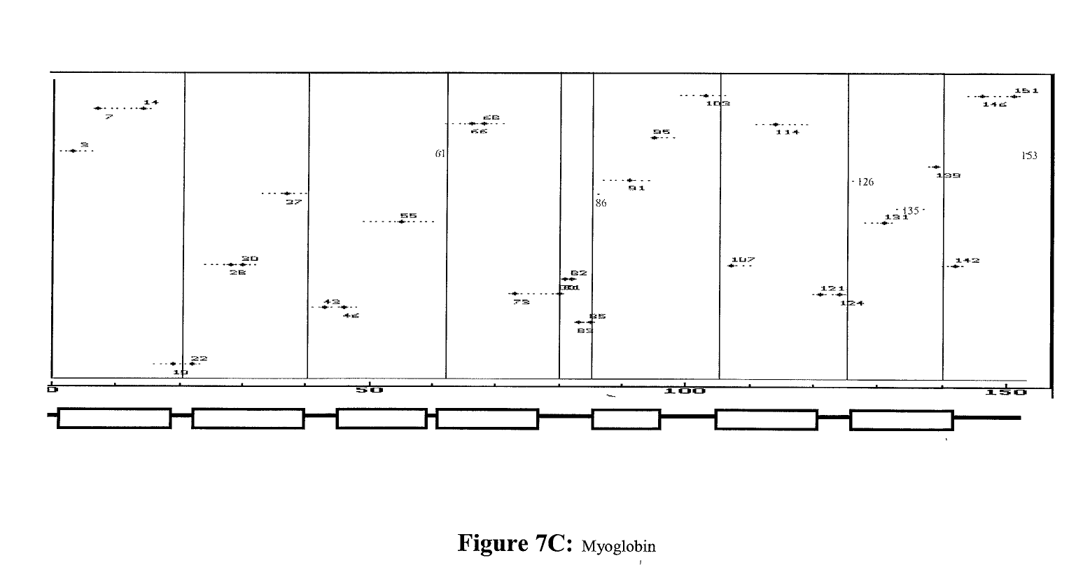

PVDs for each amino acid in myoglobin and HIV protease were prepared as described in Example 1 (i.e., using the conditions FD_{P}=I*D*F, where I is a triangular impulse function having width W=20, D=1/d, and F=1.0). Next, the CLM (X=1) for each PVD was determined and used to construct two-dimensional LMDMs, as shown in FIGS. 6A and 6B. Context centers (including TCC) were identified on the LMDMs and used to parse the sequences into predicted secondary structure units, based upon the rule that each segment of secondary structure would include four context centers. The secondary structure boundaries predicted for myoglobin using this method agree nicely with the boundary predictions determined using DSSP and X-ray crystal structure coordinates (see FIG. 7C).

Using the same methods, LMDMs were constructed for the IgG binding domain of Protein G and the p53 DNA binding domain, and secondary structure boundaries were subsequently predicted using the rule that each segment of secondary structure would include four context centers. FIGS. 6A and 6B show that the secondary structure boundaries predicted using LMDMs and the four context center per secondary structure rule closely match crystallography-based secondary structure boundary predictions.

### Example 3

### Use of the PVD to Identify Protein-Protein Interaction Sites

PVD values for all N_{A} monomer positions in the sequence of yeast APC11 were determined using the methods of Example 1, with W=3. Next, PVD values for all N_{B} monomer positions in the sequence of protein B (selected from several other yeast proteins, including CDC16, CDC23, CDC26, CDC27, APC2, APC4, APC5, APC9, and DOC1), were determined, also using the methods of Example 1. Potential protein-protein interaction surfaces between APC11 and each of the other yeast proteins were identified by calculating N_{A}×N_{B} difference matrices and plotting the regions of each difference matrix having minimal values, Dᵢⱼ<10% of the maximal difference in the difference matrix. APC11, which is known to interact with all of the B proteins tested, appears to interact with all of the B proteins via its C-terminal region, e.g., about amino acid residues 120-180 (see FIG. 8A). Furthermore, according to the graphs, APC11 has the most extensive interactions with APC 4, APC5, APC2, CDC16, CDC23, and CDC27, and the least extensive interactions with CDC26 and particularly DOC1. It is also noteworthy that the APC11-interaction surfaces of the CDC proteins tend to be located in the same regions, particularly for CDC23 and CDC17 (see the distribution along the X-axis). Likewise, the APC11-interaction sufaces of the APC proteins tend to be located in the same regions, particularly for APC4 and APC5 (again, see the distribution along the X-axis).

Similarly, PVD values for all N_{A} monomers in the sequence of yeast CUP2 and all N_{B} monomers in the sequence of protein B (selected from proteins VP 535, TP01, YKR011c, and YOR220w) were determined using the methods of Example 1. N_{A}×N_{B} difference matrices were calculated as described above and, for each difference matrix, the difference matrix elements having minimal value were plotted on a graph (see FIG. 8B). Yeast CUP2 is predicted to interact with each of the other four proteins on the same surface, which includes amino acid residues 75 to 165.

### Example 4

### Use of PVDs to Produce Context Maps for Determining Protein Fold Sub-Families

A GCS was generated for HIV protease using the criteria (X,t)=(3,2). Cohesion energies were used to scale the GCS. Cohesion energies for the 20 natural amino acids have been evaluated by K. Timberlake (1998), Chemistry of Life, Addison Wesley. The results are shown in FIG. 11. The resulting pattern is a structural signature that can be used to compare HIV protease to other proteins, which could result in the identification of proteins that are structurally homologous to HIV protease, but lack significant primary sequence homology.

### Example 5

### Use of the CFS to Determine the Identity of Secondary Structure Segments

G-profiles were generated as described above for HIV protease, using W=30 for construction of PVDs. Based on the identification of secondary structure boundaries described in Example 2, positions within each of the secondary structure segments were identified and their corresponding PVDs were used to produce each of the G-profiles shown in FIG. 12A. The G-profiles were analyzed for “islands” pointing to positions in the protein sequence other than the PVD reference position. For example, the G-profile constructed using the PVD of position 69, shows two islands pointing to positions 21 and 28, indicating contextual similarity between positions 69 and both positions 21 and 28. A book graph summarizing the results of all of the G-profiles is shown in FIG. 12B.

### Example 6

### Identification of Active Site Composition

For a given protein sequence, calculate the GFD's at the optimally selected width W for the probing impulse. Normalize the calculated elements of the GFD matrix. Display results in a two-dimensional plot rendering only those with positive values larger than an optimal threshold value. In these examples, 0.75 is typically used as the optimal threshold and W=N/2 as the optimal probing width. Use a suitable algorithm for determination of correlated islands in this two dimensional rendering to determine the segments that are contextually most unique and recognizable irrespectively of the reference position in the sequence. These contextually unique and correlated segments are constituents of enzymatic active sites as shown in the examples in FIG. 14. When this information is combined with predictions of secondary structure boundaries, it is immediately possible to predict if particular parts of the active site are composed of regular secondary structure segments (helix, sheet, key etc.) or if it is a loop of the super secondary structural motif (e.g. turn in the helix-turn-helix super secondary structure).

### Example 7

### Determination of the Effect of Mutations on Protein Function and Activity

For a given sequence, predict the boundaries of secondary structures using the optimal probing impulse calculated from the sequence length N and Eqn (4). From this prediction, determine the average length Nav of the regular secondary structure segments that are predicted for the sequence. Recalculate the GFD for the analyzed sequence with the impulse width set optimally to Nav/2 or smaller. Find the maximal values of the elements of GFD at position P and the second maximal value of the GFD at position R for the segments shown by large off-diagonal GFDPR values. Plot the row vector of the GFD at position P and the column vector of the GFD at position R as shown in FIG. 15. These plots allow calculations of the mutation propensity at position P. This is done by using the largest GFD value at position P or average of the two values of the two GFD vectors together with the PVD elements associated with that position P.

Skiba, M. C., Logan, K. M. & Knight, K. L. (1999) Intersubunit Proximity of Residues in the RecA Protein as Shown by Engineered Disulfide Crosslinks.

Biochemistry 38, 11933-11941.

Our data shows that mutations at Lys6 and Arg28 impose severe defects in RecA oligomer stability, whereas mutations at positions 112, 113 and 139 do not. . . .

insertion of Phe217 into a hydrophobic pocket in subunit 2 which in turn affects the position of residues in that subunit involved in cooperative filament assembly as well as ATP binding and hydrolysis.

### Example 8

### Prediction of Regions of High SNP Propensity

An example of one way SNPs are analyzed by DNA microarray technology is the Affymetrix™ Genechips™. For HIV, which mutates rapidly, it is necessary to redundantly query regions where mutations are known to occur. This approach is obviously limited by the extent and timeliness of knowledge regarding the locations of SNPs. The HIV Genechip™ comprises a set of oligonucleotides, 15-20 base long, which represent windows of sequence along the known HIV genome sequence. Mismatches are placed at varying positions in the oligos in order to distinguish between a SNP or wild-type base pair. Many assumptions about the resultant mismatches that occur in order to accurately detect the wild type or SNP sequences are not entirely accurate, especially in multiplex environments in which DNA microarray hybridization occur. However, in any SNP application, the goal must be to devise a way to cover the entire gene sequence with appropriately designed sets of probes that will result in highly accurate and repeatable answers.

The methods of the present invention can be used to generate a mutation and drug resistance profile of an amino acid sequence. The profile is aligned back onto the original gene encoding the protein, and areas of high and low mutation propensity are denoted. The result is the areas most likely to contain SNPs, the likelihood the SNP will occur, and where to position query mismatches in a set of probes designed to detect SNPs. Mismatches occurring at different places within the same oligonucleotide do not result in identical destabilization due to context effects. Identification of regions likely to contain or not contain SNPs can be performed as follows:

A. For a given protein sequence, calculate the GFD at the optimally selected width W for the probing impulse.

B. Find the global maximum (iₘₐₓ, jₘₐₓ) and store the projection of the GFD on the x-z or y-z plane at that position. The projected graphs contain the amino acid residue positions plotted versus the values of the GFD at each position.

C. Expand the profile from step (B) in terms of the DNA sequence. That is, for each amino acid residue replace it with the corresponding codon sequence. This can be done either uniformly, i.e. the same value on the amino acid profile is assigned to all three DNA positions or non-uniformly, i.e. each of the three positions in the DNA sequence can be assigned a different weight that scales the resulting value on the corresponding DNA profile. For example, weighting could correspond to codon frequencies, degeneracy, bias, etc.

D. Define the desired length of the DNA oligomer probes. Determine and tabulate every possible subsequence with this length of the gene sequence, covering the entire sequence, and store them in a database. Group the sequences into further sub-subsets according their percent overlap with every other sequence.

E. For each sub-subset determine the cross hybridization propensity by sequence alignment, thermodynamic stability calculations or other methods known in the art. Weight each position of the sub-subset sequences in the DNA sequence by the cross hybridization propensity of the corresponding oligomer. The actual functional form of the weighting corresponding to the cross hybridization propensity may be complicated and./or empirically determined.

F. The profile determined from the GFD and the weighting function for cross-hybridization propensity are mathematically combined (multiplied) and the resulting weighted profile is plotted. Features of the weighted profile indicate regions where SNP occurrence might have the greatest relative effect on the sequence context. That is, minima on the profile are regions where a SNP might have little effect on the overall context, while maxima would be influenced most by the base change introduced by the SNP.

This method allows for an integrated format that will result in a set of unique features and sequence assay set design criteria to query expression profiles directly and efficiently for any gene sequence with regards to gene and gene product biological properties (e.g. SNPs, mutation type, structure and function of protein product, links to biological pathways, such as metabolism or signal transduction, fold family annotations and signatures coupled to genomic information). This method requires knowledge of links to known and actually translated (real) genes into their corresponding amino acid sequences, and thus requires full-length gene sequences or reliable links between EST targets and their correspondence to full-length genes that they serve to identify in expression profiling methodologies.

The described embodiments of the invention are intended to be merely exemplary and numerous variations and modifications will be apparent to those skilled in the art. All such variations and modifications are intended to be within the scope of the present invention. All cited publications are incorporated herein in their entirety by reference.

What is claimed:

1. A method of representing a polymer sequence, the method comprising:
obtaining a position vector descriptor (PVD) for one or more positions in the polymer; and
replacing the monomer(s) with the corresponding PVD(s) in the representation of the polymer.

2. The method of claim 1, wherein obtaining a PVD comprises:
calculating functional descriptors (FD_{P}s) for each position in the polymer, wherein the FD_{P}s are calculated with respect to a specific pre-selected monomer, P; and
combining the calculated FD_{P}s into a single vector having m elements, where m is equal to the number of different types of monomers in the polymer.

3. The method of claim 2, wherein the FD_{P}s are calculated using the formula:
FD_{P}=I*D*F, if the associated monomer is at a position other than P; and
FD_{P}=I*F, if the associated monomer is at position P,
wherein I is an impulse function, D is a distance function, and F is either a function describing a physical parameter of each monomer in the polymer or F=1.

4. The method of claim 1, wherein the PVD(s) is/are simplified to include only a subset of elements.

5. The method of claim 4, wherein the PVD(s) is/are simplified to include only a single element, the context leading monomer (CLM).

6. The method of claim 1, wherein the polymer is a protein.

7. A method of predicting the effects of a change in the sequence of a protein, the method comprising:
obtaining a mathematical relationship that predicts the effects of a change in the sequence of a protein, wherein the input variable for the mathematical relationship is the difference between the value of a PVD element corresponding to the changed monomer and the value of a PVD element corresponding to the original monomer, and wherein the two PVD elements are from the same PVD and the PVD represents the position at which the change is located in the protein;
obtaining a PVD representing a position of interest in the protein; and
using (i) the difference between elements of the PVD representing the position of interest in the protein and (ii) the mathematical relationship to calculate the predicted effects of a change in sequence of the protein.

8. The method of claim 7, wherein the effect being predicted is protein stability.

9. A method of predicting secondary structure boundaries in a protein sequence, the method comprising:
obtaining PVDs for some or all amino acid position in the protein sequence;
constructing a leading monomer distribution map (LMDM) for the protein; and
dividing the LMDM into segments representing predicted units of secondary structure.

10. The method of claim 16, wherein a fixed number of context centers on the LMDM define each segment of secondary structure.

11. A method for identifying structural homologs of a protein, the method comprising:
obtaining PVDs for some or all amino acid positions in the protein sequence;
determining the effective primary sequence of the protein; and
searching a protein database for sequences homologous to the effective primary sequence of the protein.

12. The method of claim 11, wherein the sequences present in the protein database are effective primary sequences.

13. A method of identifying positions of contextual similarity in a pair of polymers, the method comprising:
a) obtaining a first set of PVDs describing one or more positions in the first polymer and a second set of PVDs describing one or more positions in the second polymer;
b) calculating a difference matrix for the first set of PVDs with respect to the second set of PVDs;
c) identifying the elements in the resulting difference matrix that are within a pre-selected range; and
d) optionally, graphing the identified elements.

14. A method of identifying positions of contextual similarity in a polymer, the method comprising:
a) obtaining a set of PVDs describing one or more positions in the polymer, wherein the set of PVDs has been simplified to include a reduced number of elements, X;
b) performing pair-wise comparisons of each PVD (CL_{X}PVD) from the set of PVDs, wherein two PVDs that have a threshold number, t, of CLMs in common are identified as representing monomer positions that are contextually similar; and,
c) optionally, generating a matrix (E-MAAP™) representing the results of step (b).

15. The method of claim 14, further comprising the steps:
d) repeating steps (a), (b), and (c) using PVDs constructed for multiple impulse function widths, W; and
e) summing the matrices resulting from step (d) to produce a global matrix (E-MAAP™).

16. A method of identifying proteins that have similar structural folds, the method comprising:
obtaining a first scaled E-MAAP™, wherein the E-MAAP™ is scaled using amino acid cohesion energies;
obtaing a second scaled E-MAAP™, wherein the E-MAAP™ is scaled using amino acid cohesion energies, and wherein the polymer sequence of the second scaled E-MAAP™ is different from the polymer sequence of the first scaled E-MAAP™; and
determining the similarity of the second scaled E-MAAP™ with respect to the first scaled E-MAAP™.

17. The method of claim 16, comprising:
repeating the method with the same first scaled E-MAAP™ but different second scaled E-MAAP™s from the database, and
optionally, ranking the E-MAAP™s of the database with respect to their similarity to the first scaled E-MAAP™.

18. A method of estimating the folding rate of a protein, the method comprising:
obtaining a scaled E-MAAPTM, wherein the E-MAAP™ is scaled using the Richardson hydrophobicity scale;
making a three-dimensional representation of the scaled E-MAAP™;
integrating the positive volume of the three-dimensional representation;
and using the value resulting from the integration to estimate the folding rate of the protein.

19. A method of identifying positions of contextual similarity in a pair of polymers, the method comprising:
a) obtaining a first set of PVDs describing one or more positions in the first polymer and a second set of PVDs describing one or more positions in the second polymer, wherein the PVDs of the first and second set of PVDs have been simplified to include a limited number of elements, X;
b) performing pairwise comparisons of each PVD (CL_{X}PVD) from the first set of PVDs with each PVD (CL_{X}PVD) from the second set of PVDs, wherein two PVDs that have a threshold number, t, of CLMs in common are identified as representing monomer positions that are contextually similar; and,
c) optionally, generating a matrix (E-MAAP™) representing the results of step (b).

20. The method of claim 19, further comprising the steps:
d) repeating steps (a), (b), and (c) using PVDs constructed for multiple impulse function widths, W; and
e) summing the matrices resulting from step (d) to produce a global matrix (E-MAAP™).

21. A method of predicting an interaction between two polymers, the method comprising:
scaling the values of the matrix produced by the method of claim 20 using amino acid cohesion energies; and
identifying positive peaks in the values of the matrix.

22. A method of representing a polymer sequence, the method comprising:
obtaining a PVD representing a position in the polymer sequence; and
using the elements of the PVD to construct a Context Functional Surface (CFS) for one or more positions in the polymer sequence.

23. The method of claim 22, wherein the set of CFSs corresponding to some or all of the monomer positions in the polymer are combined to generate a CFS having an additional dimension.

24. A method of characterizing secondary structure segments in a protein, the method comprising:
a) obtaining a PVD representing a particular monomer position, R, in the protein;
b) using the PVD of step a) to generate a CFS for some or all monomer positions in the polymer;
c) plotting the positive values of the CFSs of step b) on a single graph to produce a G-profile; and
d) analyzing the G-profile.

25. A method of characterizing the contextual similarity of different positions in a polymer, the method comprising:
a) obtaining a PVD representing a particular monomer position, R, in the polymer;
b) using the PVD to generate a set of CFSs for some or all positions in the polymer;
c) calculating an correlation matrix, r_{R}, for the set of CFSs generated in step b);
d) repeating steps a) through c) for some or all positions, R, in the polymer; and
e) using the correlation matrices of step d) to generate a GCD for the polymer.

26. A method of identifying contextually unique positions in a polymer, the method comprising:
obtaining a GCD for the polymer; and
identifying elements in the GCD that are greater than or equal to a predetermined threshold value; and
identifying correlated islands in the set of GCD elements identified as exceeding the threshold value.

27. A method of predicting the effects of mutations on the structure of a protein, the method comprising:
a) obtaining a GCD for the protein;
b) identifying a position P in the GCD;
c) identifying a position R in the GCD;
d) plotting the row vector of the GCD at position P and the column vector of the GCD at position R on the same graph; and
e) identifying peaks in the graph,
thereby identifying positions in the protein that are predicted to disrupt the structural stability of the protein when mutated.

28. The method of identifying positions in a nucleic acid sequence, the method comprising:
a) obtaining a GCD for a protein encoded by the nucleic acid sequence;
b) identifying a position P in the GCD;
c) identifying a position R in the GCD;
d) plotting the row vector of the GCD at position P and the column vector of the GCD at position R on the same graph; and
e) identifying positions in the graph corresponding to positions in the protein that are predicted to influence the structural stability of the protein; and
f) identifying regions of the nucleic acid sequence that encode the amino acids identified in step e),
thereby identifying positions in the nucleic acid sequence that are likely to contain SNPs.
